(19) United States
(12) Patent Application Publication
(10) Pub. No.: US 2026/0291191 A1
(43) Pub. Date: Sep. 24, 2026

(54) A CABLE ROUTER AND A LOAD HANDLING DEVICE

(71) Applicant: OCADO INNOVATION LIMITED, Hatfield, Hertfordshire (GB)

(72) Inventors: Mathias NORDQVIST, Hatfield, Hertfordshire (GB); Clifton HOYLE, Hatfield, Hertfordshire (GB); Måns Fredrik Jonathan NILSSON, Hatfield, Hertfordshire (GB); Wilhelm Karl JOHANNISSON, Hatfield, Hertfordshire (GB)

(73) Assignee: OCADO INNOVATION LIMITED, Hatfield, Hertfordshire (GB)

(21) Appl. No.: 18/881,139

(22) PCT Filed: Jul. 3, 2023
(86) PCT No.: PCT/EP2023/068273

§ 371 Date: Jan. 3, 2025

(30) Foreign Application Priority Data
Jul. 4, 2022 (GB) 2209774.5
Jul. 4, 2022 (GB) 2209795.0

(51) Int. Cl. H02G 3/04; B65G 1/04; H02G 3/22; H02G 3/32; H02G 15/007

(52) U.S. Cl. CPC H02G 3/0437; B65G 1/0464; B65G 1/0492; H02G 3/22; H02G 3/32; H02G 15/007

(57) ABSTRACT

A cable router includes a spine having two opposing longitudinal members, and a plurality of ribs spaced apart from each other along the spine and connecting the two longitudinal members. The spine and the ribs together provide a cable receiving space therebetween. The longitudinal members have a width extending in a plane transverse to the longitudinal direction of the spine, and the width of the longitudinal members inhibits the cable router from bending in the plane in which the width extends. At least a portion of the spine is moveable between a first configuration and a second configuration, wherein the spine is biased to the first configuration.

### FIELD OF INVENTION

The present invention relates to a cable router for routing cabling between at least two devices or components which comprise one or more cables. In particular, but not exclusively, the invention relates to routing cabling between at least two components of a load handling device used for handling storage containers in the storage and retrieval system comprising a grid framework structure.

### BACKGROUND

Storage and retrieval systems comprising a three-dimensional storage grid framework structure, within which storage containers/bins are stacked on top of each other, are well known. PCT Publication No. WO2015/197709A (Ocado Innovation Limited) describes a known storage and fulfilment or distribution system in which stacks of bins or containers are arranged within a grid framework structure. The bins or containers are accessed by load handling devices remotely operative on tracks located on the top of the grid framework structure.

A system of this type is illustrated schematically in FIGS. 1 to 3 of the accompanying drawings. As shown in FIGS. 1 and 2, stackable containers, known as storage bins or containers 10, are stacked on top of one another to form stacks 12. The stacks 12 are arranged in a three dimensional grid framework structure 14 in a warehousing or manufacturing environment. The grid framework structure is made up of a plurality of storage columns or grid columns. Each grid in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application. Bins 10 may also be referred to as storage bins or containers or storage containers or totes.

In detail, the three dimensional grid framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a grid structure or grid 15 comprising a plurality of grid cells 17. The grid cell has an opening to allow a load handling device to lift a container or storage bin through the grid cell. In the grid structure, the first set of parallel horizontal grid members 18 intersect the second set of parallel horizontal grid members at nodes. The grid structure is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

A known load handling device or robotic load handling device otherwise known as a bot 30 shown in FIGS. 4 and 5 comprising a vehicle body 32 is described in PCT Patent Publication No. WO2015/019055 (Ocado Innovation Limited), hereby incorporated by reference, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the grid structure.

WO2017/153583 (Ocado Innovation Limited) teaches a load handling device comprising a wheel positioning mechanism or directional change mechanism for enabling lateral movement of the device in one of two transverse directions by enabling either a first or second set of wheels to selectively engage the first or second set of rails or tracks (22a or 22b). The wheel positioning mechanism comprises a complicated arrangement of linkages driven by a linear actuator or motor to selectively lower or raise the first set of wheels or the second set of wheels into engagement or disengagement with the first set of tracks or rails or the second set of tracks or rails.

The load handling device 30 is equipped with a lifting mechanism or container lifting mechanism or crane mechanism to lift a storage container from above. The crane mechanism comprises a winch tether or cable 38 wound on a spool or reel (not shown) and a grabber device 39 in the form of a lifting frame. The lifting device comprise a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess 41, in the lower part. The recess is sized to accommodate the container 10 when it is lifted by the crane mechanism, as shown in FIG. 5 (a and b). When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS), in which case the container receiving space is located below a cantilever of the load handing device. In this case, the grabber device is hoisted by a cantilever such that the grabber device is able to engage and lift a container from a stack into a container receiving space below the cantilever.

Typically, the load handling device comprises one or more electrical components such as a rechargeable power source to provide power to the drive units for operating the lifting mechanism and the wheel positioning mechanism and a control unit. For example, one or more load handling devices remotely operable on the grid structure are configured to receive instructions from a master controller to a retrieve a storage container from a particular a storage location within the grid framework structure. Wireless communications and networks may be used to provide the communication infrastructure from the master controller via one or more base stations to the one or more load handling devices operative on the grid structure. A controller in the load handling device in response to receiving the instructions is configured to control various driving mechanisms to control the movement of the load handling device. For example, the load handling device may be instructed to retrieve a container from a storage column at a particular location on the grid structure. The instruction can include various movements in an X-Y direction on the grid structure. Once at the storage column, the lifting mechanism is then operated to grab the storage container and lift it into a container receiving space in the body of the load handling device where it is subsequently transported to another location on the grid structure commonly known as a drop off port. The container is lowered to a suitable pick station allowing retrieval of the item from the storage container. Movement of the load handling devices on the grid structure also involves the load handling devices being instructed to move to a charging station which is usually located at the periphery of the grid structure. The electrical components of the load handling device are typically housed within the body of the load handling device.

Considering the number of components, which includes various motors, pulleys and electrical components such as a battery and control board needed for the load handling device to operate on the grid framework structure, the assembling of the individual components together is one of biggest costs in the manufacture of a load handling device. Considering that there are hundreds of load handling devices operable on the grid framework structure, the cumulative costs of multiple load handling devices operable on the grid structure represent a significant proportion of the cost of a typical storage and retrieval system. The mechanical components of the load handling device are powered and controlled by electrical components, and thus a network of cables is required to operate each load handling device. The cables can be routed around the load handling device using cable ties attached to various components. However, using cable ties does not easily allow the positioning and routing of the cables in a reproducible manner. Further, if the cables are not correctly positioned and routed, this can cause the load handling device to malfunction, or even additionally cause an adjacent load handling device to malfunction if one or more of the cables is located outside the footprint of the load handling device and interacts with the adjacent load handling device. Further, maintenance of a load handling device takes up valuable time, and considering the hundreds of load handling devices operable on the grid framework structure, the cumulative maintenance time for multiple load handling devices operable on the grid structure represents a significant proportion of the lifetime of a load handling device.

A load handling device is thus required that addresses these problems.

It will be appreciated that while the devices, apparatus, system and methods described herein are described using grocery systems as an example, automated or semi-automated storage and retrieval systems are not limited to systems directed to groceries. For example, the technology can be applied to shipping, baggage handling, vehicle parking, indoor or hydroponic greenhouses and farming, modular buildings, self-storage facilities, cargo handling, transport switchyards, manufacturing facilities, pallet handling, parcel sortation, airport logistics (ULD) and general logistics to name but a few possible applications. It will be appreciated that storage and retrieval systems of different types will have different technical requirements.

This application claims priority from GB patent application numbers GB2209774.5 filed 4 Jul. 2022 and GB 2209795.0 filed 4 Jul. 2022, the contents being herein incorporated by reference.

### SUMMARY

Aspects of the invention are set out in the accompanying claims.

A component for retaining a cable is provided. The component comprises a body portion, one or more grooves to define an elongated channel integrated within the body portion for routing one or more cables along or around the body portion; the grooves comprising a cable retaining mechanism for retaining the cable within the groove; wherein the groove does not exceed a pre-defined minimum bend radius characteristic of a cable. Specifically the cable may be for retaining therein.

The component may be suitable for retaining a cable in a device, in particular, the component may be suitable for retaining a cable in a load handling device.

The grooves protect the integrity and performance of a cable by ensuring that the retained cable does not exceed a pre-defined minimum bend radius. The ‘pre-defined minimum bend radius characteristic of a cable’ is also termed a ‘minimum bend radius’ or a ‘minimum bending radius’ or a ‘cable bending radius’ or a cable bend radius' in this application. The minimum bend radius is a measurement of the smallest radius a cable can be bent without damaging the cable. The cable minimum bend radius is dependent on the cable diameter, the cable rating (for example, the temperature rating, the voltage rating and the current rating), whether the cable is static or moving, the cable construction, the conductor type (for example, copper, copper-covered steel, high strength copper alloys, and aluminium), the sheathing (for example, polyvinylchloride (PVC), polyurethane (PU), polyethylene (PE), polytetrafluoroethylene (PTFE) etc.) and insulation types (for example, thermoset or thermoplastic) used. If the cable minimum bend radius is exceeded, the cable can show kinking or other sheath damage which indicates that there could be other potential problems with the cable, which may cause the device to malfunction.

For example, a cable may be between 5 mm and 8 mm in diameter. A 5 mm diameter cable may have a minimum bend radius of approximately 25° for a static cable, a 6 mm diameter cable may have a minimum bend radius of approximately 30° for a static cable, a 7 mm diameter cable may have a minimum bend radius of approximately 35° for a static cable and a 8 mm diameter cable may have a minimum bend radius of approximately 40° for a static cable. Typically, the minimum bend radius for a static cable is around 5 times the diameter of the cable. In contrast, the minimum bend radius for a moving cable is around 10 times the diameter of the cable. The one or more grooves constrain the cable so that the cable is not damaged as a result of routing it around the component. The one or more grooves define an elongated channel which is dependent on the shape of the component, the position of the component in relation to the device, for example a load handling device, the position of electrical and mechanical elements in the device and also the same features of the cable that affect the minimum bend radius as listed above. Thus, the elongated channel is bespoke to each component.

The grooves which define the elongated channel are integrated within the body portion of the component. This is particularly advantageous because it means that the cable is retained within the shape of the component which results in fewer malfunctions of the device, for example, a load handling device, because the cable is retained away from moving parts and does not obstruct the moving parts (for example, a container being lifted by a container lifting mechanism, the directional change mechanism etc.) of the device. Thus, the likelihood of the cable retained with groove being caught in a moving part of a load handling device is significantly reduced. Further, as a result of being constrained within the one or more grooves, the cable cannot extend outside the footprint or overall shape of a load handling device, which therefore avoids the cable being ripped from the load handling device when passing or being passed by another load handling device. Thus the grooves of the component retain the cabling such that clearance can be maintained between two load handling devices passing each other.

A further advantage of having an elongated channel which is integrated within the body portion of the component is that the cables are easily accessible for maintenance. In contrast to using cable ties which require scissors or snippers to cut the cable ties and release the cable, the cable can be removed from the component without using any tools and without damaging or affecting the component. If new cables are to be fitted, the cables can be replaced quickly and easily and routed in exactly the same way as before, ensuring that the pre-defined minimum bend radius of the cable is not exceeded, the cable is clear of moving parts and the cable is routed correctly to the appropriate part of the device. Thus the one or more grooves defining an elongated channel integrated within the body portion of the component as defined in the claims provides a convenient, reliable and accessible means for routing a cable around a component.

The body portion of the component is understood as forming the bulk of the component and acts like a frame to support various elements (for example, mechanical or electrical elements/components) of the load handling device. The one or more grooves which define an elongated channel run through the body portion, and may be routed along or around the exterior, interior or a mixture of both the exterior and interior of the body portion. The body portion may comprise an interior curvature and/or external curvature, and the one or more grooves follow the interior curvature and/or exterior curvature of the body portion. This results in the one or more grooves being curved and meandering around the body portion. In this context, the term ‘interior curvature’ means curvature through the body portion and/or curvature along an interior surface of the body portion. The term ‘exterior curvature’ in this context means curvature on the outside of the body portion. The body portion may be topology optimised through material reduction thereby forming the interior and/or exterior curvature. The one or more grooves may also be routed around fasteners and/or fixings in the body portion.

The one or more grooves may be understood as being depressions within the body portion in which one or more cables can be routed. The grooves may be C-shaped. The one or more grooves define an elongated channel. Both the one or more grooves and the elongated channel are integrated within the body portion for routing one or more cables along the body portion. The elongated channel may be understood as being a path through which the cables are routed.

Optionally, the cable retaining mechanism may be integrated within the body portion. This means that the component requires no additional retaining elements to retain the cable within the grooves, which is more convenient for assembly of the device. The cable retaining mechanism may comprise a plurality of tabs spaced apart along the groove. This advantageously allows the cable to be fed under each individual tab and thus routing the cable along the elongated channel is a simple process. Further, the cable can easily be removed from the elongated channel by withdrawing the cable from each individual tab. By having a plurality of tabs spaced apart along the groove, the cable may be retained along the length of the groove. The plurality of tabs may be positioned on alternate sides of the groove, which provides improved retention of the cable within the groove.

The cable retaining mechanism may comprise a clip for engaging with the groove. The clip may be integrated within the body portion. For example, the clip may have resiliency such that the clip can flex to an open state to allow a cable to be inserted under the clip. Further, when the cable is inserted under the clip, the clip may automatically resume a resting/closed state in which the clip fastens and pushes the cable into the groove. Alternatively, the clip may be hinged along the groove and provide an open state to allow the cable to be inserted under the clip and a closed state such that the clip fastens (for example, by a snap-fit mechanism) and pushes the cable into the groove.

Alternatively, the clip may be a separate piece engageable with the groove of the component. For example, the clip may be insertable into the groove and the clip may be configured to provide a snap-fit engagement with the groove. The clip and the groove may therefore have interlocking features which allow the clip to be pushed and retained in the groove and thereby retain a cable in the groove. Advantageously, the snap-fit engagement provides a quick and easy way to fit the clip within the groove and does not require any further parts, such as screws, to keep the clip retained within the groove. Optionally, the clip may be configured to provide a cantilever snap-fit engagement with the groove. Optionally, the clip comprises flexural arms for engaging with the groove and for pushing onto the cable such that there is no relative motion between the cable and the clip. The flexural arms allow the clip to be fitted into position within the groove when the arms are flexed inwards, and once the clip is in position, the flexural arms return to a relaxed position and the clip is retained within the groove.

Optionally, a portion of the groove may be configured to receive an overmoulded cable.

Overmoulded cables are assemblies that combine a cable and connector into a single piece. A cable assembly is placed inside a mould into which molten plastic material is injected. Once the polymer material cools and solidifies, the polymer material conforms to the shape of the mould and encapsulates the junction point between the connector and the cable/wire. The overmoulding process is therefore an injection moulding process. Overmoulded cables generally have an improved lifespan and reliability. Further overmoulded cables can be configured such that an excess length of cable (slack) is built into the cable thereby eliminating the need for absolute accuracy in the length of the cable. In addition to combining the cable and connector into a single piece, the cable can also be overmoulded at points along the length of the cable without the presence of a connector. Thus the size and shape of the portion of the groove may be complementary to the size and shape of the overmoulded cable. This allows the overmoulded cable to clip or be pushed into the portion of the groove and be retained within the groove. In particular, the overmoulded section of the cable provides a greater surface area to engage with the portion of the groove having a complementary size and shape to the overmoulded section, and thus the cable is more firmly gripped in the portion of the groove.

Optionally, the portion of the groove may be shaped to allow the overmoulded cable to be twisted and retained in the portion of the groove. The portion of the groove may allow the overmoulded cable to be pushed into the groove at an angle, and may then allow the overmoulded cable to be rotated such that the overmoulded cable is in a position in which it is retained in the portion of the groove. The overmoulded cable may be rotated such that it is positioned in line with the length of the groove. Specifically, after rotation of the overmoulded cable, the overmoulded cable may be positioned fully within the groove and aligned with (the direction of) the length of the groove. This particular configuration of the groove means that the cable may be firmly retained within the groove such that the cable cannot move in a longitudinal, transverse or axial direction, and cannot be removed from the portion of the groove without rotating/twisting the overmoulded cable in the portion of the groove and sliding the overmoulded cable out from the portion of the groove. The overmoulded cable may be retained in the portion of the groove by tabs which restrict movement of the overmoulded cable.

Additionally, the overmoulded cable may be retained in the portion of the groove by a clip, such as a clip with a snap-fit arrangement.

Optionally, the portion of the groove has a shape complementary to the shape of the overmoulded cable such that the overmoulded cable can be pushed into position in the portion of the groove. This push-fit arrangement may be a quick and easy arrangement for routing the cable and stops the cable from moving in longitudinal, transverse and axial directions. The push-fit arrangement can be configured to accommodate and retain different overmoulded cable shapes, such as a square shape, a star shape, the shape of a bobbin, etc. The component may comprise a clip for engaging with the overmoulded cable and the portion of the groove. The clip may aid in stopping the overmoulded cable from being easily removed from the portion of the groove, for example for the push-fit arrangement. The clip may comprise the same features as the clip having the snap-fit arrangement.

Optionally, a portion of the groove may be straight or substantially straight. Thus, in this portion of the groove, there is no bend radius. There are many arrangements and configurations that the groove can have as a result of the groove having both straight and bent portions. Thus the groove can be routed around various mechanical and electrical elements located in and around the component. Further, by having a straight portion of the groove, the amount of cable required in the component can be reduced, which reduces the complexity of routing the cable and also reduces the overall cost of the device.

Optionally, the groove may comprise one or more bend radii. An advantage of having a groove comprising at least one (or one or more) bend radii in the component is that the cable can be routed in various different arrangements around various mechanical and electrical elements located in and around the component. Thus, the groove can be routed to suit the individual cable and elements in and around the component.

The groove may comprise a first section and a second section, wherein the first section has a groove diameter greater than a groove diameter of the second section. This configuration of the groove allows a different cable to be encased in different sheaths along the length of the cable. Further, having a greater groove diameter may enable a clip to be inserted into the first section of the groove and retain a cable positioned in the groove. Further still, an overmoulded section of the cable may be inserted into the first section having a greater groove diameter than the second section, thereby inhibiting movement of the cable in a transverse direction in the groove and inhibiting movement of the cable in a longitudinal direction along the length of the groove up to the second section which may not be able to accommodate the overmoulded section of the cable.

At least a portion of the groove may comprise an open sided cross-sectional profile. For example, the open sided cross-sectional profile may be C-shaped, U shaped, V-shaped, W-shaped etc. The open sided cross-sectional profile provides a space or open section to allow a cable to be inserted into the groove. The open sided cross-sectional profile also allows a cable to be easily removed from the groove. The open sided cross-sectional profile allows access to the cable retained in the groove and thus maintenance time may be reduced. The space or open section may run along a portion of the length of the groove, or the open section may run along the full length of the groove.

The groove may comprise a cross-sectional profile having a shape which provides a natural resting location for the cable. This means that when a cable is retained in the groove, the cable will naturally sit or nest within the shape of the groove, rather than positioning itself at another location within the groove. The groove may have a variety of different cross-sectional profiles. The groove may comprise more than one different cross-sectional profile along its length. Alternatively, the groove may comprise only one cross-sectional profile along its length. For example, at least a portion of the groove may comprise a C-shaped cross-sectional profile. The C-shaped profile comprises curved shoulders which can engage with the cross-sectional shape of the cable. At least a portion of the groove may comprise a U-shaped cross-sectional profile, and therefore the cable will rest at the base of the U-shape. The shoulders of the U-shaped groove are flatter than the shoulders of the C-shaped groove, and the shoulders of the U-shaped groove may be spaced apart such that they accommodate the cable and touch the sides of the cable. At least a portion of the groove may comprise a V-shaped cross-sectional profile, and therefore the cable will rest at the base of the V-shape. Optionally, at least a portion of the groove may comprise a W-shaped cross-sectional profile. A W-shaped cross-sectional profile allows two cables to be guided side by side along the same groove because the groove comprises two natural resting locations. In this case, the two natural resting locations are at the base of each of the V-shapes. Alternatively, if the cross-sectional profile of the groove is C-shaped, U-shaped or V-shaped and the groove is sufficiently deep, two cables may be inserted one on top of the other into the groove. These arrangements are spatially efficient in guiding and supporting multiple cables through the body portion.

The component may comprise one or more engaging features for connecting to other components. The engaging features may be integral to the component, for example, the engaging features may be interlocking features which allow one component to push fit into another. Alternatively, the engaging features may be separate to the component, for example, the engaging features may comprise a hook, clasp, fastener etc.

The component may be formed from any of the following materials: plastic, polymer plastics, thermoset plastic, thermoplastic plastic, metals, aluminium, aluminium alloy, iron, iron alloy, steel, steel alloy, magnesium, magnesium alloy, titanium, titanium alloy, zinc, zinc alloy, fibre reinforced composite, carbon fibre, graphite fibre, glass fibre, natural fibre, plant fibre, plastic fibre, paper, cardboard, rubber, epoxy or nylon.

The component may be formed using additive manufacturing. This allows the component to be made bespoke for the specific cable construction and characteristics and for positioning other elements in the component. Thus, by using rapid prototyping/additive manufacturing, the topology of the component can be optimised to minimise the weight of the component without compensating on the strength of the component. The component can be formed from any material suitable for rapid prototyping, for example polyamide (PA 12), polyketone, etc.

A load handling device for lifting and moving one or more containers stackable in a storage and retrieval system is also provided. The storage and retrieval system comprises a grid structure comprising a plurality of grid members comprising a first set of grid members and a second set of grid members, the second set of grid members being substantially perpendicular to the first set of grid members such that the plurality of grid members are arranged in a grid pattern for guiding the movement of the load handling device on the grid structure, the load handling device comprises:
a) a container lifting mechanism comprising a grabber device configured to releasably grip a container, and a drive mechanism configured to raise and lower the grabber device;
b) a wheel assembly comprising a first set of wheels for engaging with the first set of grid members to guide movement of the load handling device in a first direction and a second set of wheels for engaging with the second set of grid members to guide the movement of the load handling device in a second direction, wherein the second direction is transverse to the first direction;
c) a wheel positioning mechanism configured for selectively lowering or raising the first set of wheels or the second set of wheels into engagement or disengagement with the first set of grid members or the second set of grid members;
d) electrical components comprising a processor for controlling the container lifting mechanism and wheel positioning mechanism;
e) a power source for powering electrical components, wherein the power source is connected to the electrical components by cabling;

wherein the load handling device further comprises:

least one component for retaining and routing cabling from the power source to the electrical components, wherein the at least one component comprises:
a body portion;
one or more grooves to define an elongated channel integrated within the body portion for routing cabling around the body portion;

grooves comprising a cable retaining mechanism for retaining the cable within the groove; wherein the groove does not exceed a pre-defined minimum bend radius characteristic of a cable.

The at least one component may comprise a component comprising any of the features described above.

Optionally, the load handling device may further comprise at least four connecting blocks, each of the at least four connecting blocks being connected to two other connecting blocks in a single modular section by one or more substantially horizontally connecting elements to form a rectangular frame, wherein the at least one component may be integral with the one or more of the four connecting blocks. By having the at least one component integral with one or more of the four connecting blocks, the cabling may be retained within the footprint of the load handling bot, and therefore the cabling does not get caught by an adjacent moving load handling device. Further the cabling does not get caught by various moving parts in the load handling device.

Optionally, the at least four connecting blocks of vertically adjacent modular sections may be connectable in a vertical stack by one or more substantially vertical connecting elements to form an open frame structure comprising a plurality of rectangular frames, said open frame structure being configured to support the container lifting mechanism, the wheel assembly, the wheel positioning mechanism and the electrical components. By having an open framed structure, the cabling can be routed along the exterior and/or interior of the connecting blocks to connect to various different elements of the load handling device. All the elements of the load handling device may be fully accessible for maintenance, as is the cabling, so the time required for carrying out maintenance on the load handling device may be reduced. The connecting blocks may be topologically optimised such that each connecting block comprises an interior curvature and/or external curvature, and the one or more grooves follow the interior curvature and/or exterior curvature of each connecting block.

The wheel positioning mechanism may be movable relative to each of the at least four connecting block, wherein the load handling device further comprises a cable router connecting the elongated channel of the at least one component integral to one of the at least four connecting blocks and the wheel positioning mechanism, the cable router comprising:
a spine, the spine comprises two opposing longitudinal members; and
a plurality of ribs, spaced apart from each other along the spine and connecting the two longitudinal members, the spine and the ribs together providing a cable receiving space therebetween,
wherein the longitudinal members have a width extending in a plane transverse to the longitudinal direction of the spine, and the width of the longitudinal members inhibits the cable router from bending in the plane in which the width extends,
wherein at least a portion of the spine is moveable between a first configuration and a second configuration dependent on movement of the wheel positioning mechanism, wherein the spine is biased to the first configuration. Thus in this arrangement, each connecting block retains a cable supported therein in a fixed position, whilst the cable router retains and guides the cable (a portion of which is supported by the connecting block) which extends between the connecting block and the moveable wheel positioning mechanism such that the cable can move as and when the wheel positioning mechanism moves. Advantageously, the combination of the component integral with one or more of the connecting blocks and the cable router allows a cable to be guided and supported around the load handling device such that the cable does not obstruct any moving parts in the load handling device. The cable router can comprise any of the features described below. The combination of the component for retaining a cable and a cable router may be termed a ‘cable retainer’, as later described.

An automated storage and retrieval system is also provided. The system comprises a grid structure comprising a plurality of grid members comprising a first set of grid members and a second set of grid members, the second set of grid members being substantially perpendicular to the first set of grid members such that the plurality of grid members are arranged in a grid pattern for guiding the movement of one or more the load handling devices operating on the grid structure; and at least one load handling device comprising any of the features described above.

A cable router is also provided. The cable router comprises a spine, the spine comprises two opposing longitudinal members; and a plurality of ribs, spaced apart from each other along the spine and connecting the two longitudinal members, the spine and the ribs together providing a cable receiving space therebetween, wherein the longitudinal members have a width extending in a plane transverse to the longitudinal direction of the spine, and the width of the longitudinal members inhibits the cable router from bending in the plane in which the width extends, wherein at least a portion of the spine is moveable between a first configuration and a second configuration, wherein the spine is biased to the first configuration.

The cable router is suitable for use with any electromechanical device which has fixed and moving parts. For example, the cable router may be suitable for use in a load handling device and may bridge a fixed or stationary piece of the load handling device (for example, a component as described above) and a moving piece of the load handling device (for example, a direction change mechanism). Alternatively, the cable router may bridge two moving pieces of the load handling device. The cable router constrains the direction in which the cables can bend. By positioning the cable router in a desired orientation, the cable router can only bend in one particular desired direction. This is particularly advantageous because the cable router can be orientated and/or positioned such that the cables do not bend outside of the footprint of the load handling device (or other electromechanical device) which avoids potential interactions with adjacent load handling devices. It may also stop cables from getting trapped by internal elements of the load handling device, for example, the wheel positioning mechanism, the container lifting mechanism etc. The cable router thereby reduces the amount of time that a load handling device is out of service for a malfunction.

The spine may be understood as providing support for the cable. The spine provides a skeletal column along which the cable runs. The spine comprises two longitudinal members. The longitudinal members run in a longitudinal direction along the length of the spine. The two longitudinal members are arranged opposite each other along the length of the spine. The width of each of the two longitudinal members is greater than the thickness (extending in a perpendicular direction to the width) of the each of the two longitudinal members. Thus the longitudinal members have rigidity running along the length of the spine and in the direction in which the width extends. The width of the longitudinal members inhibits the longitudinal members from bending in the plane in which the width extends. The cable router can therefore be orientated to bend in a desired direction. The spine may ensure that the cabling does not exceed a pre-defined minimum bend radius characteristic of the cable when the cable router and cable bend in a desired direction.

The ribs may be understood as being a series of retaining features which are articulated to the spine. The ribs may be articulated in pairs to the spine. The combination of the spine and ribs provides a cable receiving space therein. The longitudinal members retain the cable in the longitudinal direction and the ribs retain the cable in the transverse direction.

At least a portion of the spine is moveable between a first configuration and a second configuration, wherein the spine is biased to the first configuration. Biasing the spine to a first configuration ensures that the spine returns to a preferred position after being of the cable router. This means that after the moving piece of the electromechanical device or load handling device has changed position, the cable in the cable router is not left hanging loosely and can instead return to its preferred position so that the cable cannot get caught by any of the moving pieces/components. The first configuration may be therefore the preferred resting position of the cable router. The spine may be curved in the first configuration and this arrangement may minimise the stresses in the cable router.

Optionally, at least a portion of the spine may be moveable in a direction that is orthogonal to the transverse plane and orthogonal to the longitudinal direction. For example, if both the longitudinal direction and the transverse plane are horizontal, the spine is moveable in a vertical direction. Alternatively, if both the longitudinal direction and the transverse plane are vertical, the spine is moveable in a horizontal direction. Thus, the cable router can be positioned in a desired orientation so that it can bend in a desired direction.

The plurality of ribs may have an arcuate or curved shape and the plurality of ribs may be arranged to define the cable receiving space as a cylindrical channel. Thus, in this arrangement the plurality of ribs wrap around the cable to retain the cable tightly within the cable router.

Optionally, alternate ribs of the plurality of ribs may be arranged along the opposing longitudinal members. Thus, the plurality of ribs may be arranged in pairs such that one rib is attached to one of the longitudinal members and a second rib is attached to the other of the longitudinal members. This arrangement allows the cable router to wrap around both sides of the cable which makes it more difficult for the cable to come out of the cable router when the cable router is bent.

Optionally, the spine may comprise a continuous solid surface. The continuous solid surface creates a continuous channel that fully supports the cable along the length of the spine.

Optionally, a portion of the spine be made from a resilient material, for example, polyketone or polyamide. The resilient material may allow the spine to flex easily and return to its original position.

Each of the two opposing longitudinal members may be segmented into a plurality of portions. Specifically, the plurality of portions may extend along the longitudinal direction of the spine. There may be two, three, four, five, six, or between seven and ten, or more than ten portions. Having a plurality of portions allows different materials having different rigidities and/or resiliencies to be used along the spine. Preferably, the plurality of portions may comprise a combination of fixed portions and linkage portions. The term ‘fixed’ in this context means that the fixed portion does not move or rotate, i.e. it stays in the same position. The fixed portions may be connected to a fixed component and thereby support a cable in the cable retaining space along a fixed path from the fixed component. The term ‘linkage’ in this context means that the linkage portions are connected to other linkage portions and/or a fixed portion by pin joints (hinges), sliding joints, or ball-and-socket joints. Optionally, the linkage portions are pivotally connected to each other form a flexible structure, or chain. The linkage portions may form a closed chain, such that each linkage portion in the chain is connected via joints to the fixed portion and/or other linkage portions and/or a moving component, thereby constraining movement of the linkage portions. By using a plurality of linkage portions, the ends of each of the linkage portions can rotate around each joint, thereby allowing a joint to move up and down to permit bending of the cable retained within the cable receiving space in one direction (in a direction that is orthogonal to the transverse plane and orthogonal to the longitudinal direction).

Each linkage portion or fixed portion may comprise a rigid material or a resilient material. Preferably, the fixed portion comprises a rigid material. The term ‘rigid’ in this context means that the rigid material is resistant to bending. Examples of rigid materials include metals such as aluminium, steel, titanium and their alloys, thermoplastics such as polyethylene terephthalate glycol and polycarbonate, thermoset plastics such as polyesters and polyurethanes, fibre reinforced composite.

The spine may comprise a cable retaining mechanism for retaining the cable within the cable receiving space. Optionally the cable retaining mechanism may comprise a plurality of tabs spaced apart along the two opposing longitudinal members. Alternatively or additionally, the cable retaining mechanism may comprise spring loaded tabs (or detents) spaced apart along the two opposing longitudinal members. Alternatively or additionally, the cable retaining mechanism may comprise a plurality of slots configured to receive an overmoulded cable or cable comprising grommets. Grommets are circular, generally rubber, rings that can be attached to a cable and surround the circumference of the cable. Thus adding grommets to the cable provides a greater surface area to engage with the spine, and particularly the longitudinal members and ribs. Thus, the size and shape of the spine may be complementary to the size and shape of the overmoulded cable and/or the cable comprising grommets. Thus, the cable is more firmly gripped in the cable router. Additionally, the overmoulded cable and/or cable comprising grommets may be retained in the spine by a clip, such as a clip with a snap-fit arrangement, as described above. Optionally, the longitudinal members are shaped complementary to the shape of the overmoulded cable and/or the cable comprising grommets such that the cable can be pushed into position in the spine. This push-fit arrangement may be a quick and easy arrangement for routing the cable and reduces the likelihood of the cable coming out of the cable router as the cable router is flexed. The push-fit arrangement can be configured to accommodate and retain different overmoulded cable shapes, such as a square shape, a star shape, the shape of a bobbin, etc.

The cable router may further comprise a fastener for engaging with a device or component comprising one or more cables for routing. The fastener may be a clip or hook. The fastener may allow the cable router to be firmly connected to two moving parts or a moving part and a fixed component.

A device is provided, the device comprising:
a first component;
a second component moveable relative to the first component; and
a cable router according to the present invention,

wherein the cable router connects the first component and the second component such that the spine moves between the first configuration and the second configuration as the second component moves relative to the first component. In this configuration, a cable retained in the cable receiving space is supported and guided as the spine moves between the first configuration and the second configuration. The cable router may comprise any of the features described above.

A load handling device for lifting and moving one or more containers stackable in a storage and retrieval system is provided. The storage and retrieval system comprises a grid structure comprising a plurality of grid members comprising a first set of grid members and a second set of grid members, the second set of grid members being substantially perpendicular to the first set of grid members such that the plurality of grid members are arranged in a grid pattern for guiding the movement of the load handling device on the grid structure, the load handling device comprises:
a) a container lifting mechanism comprising a grabber device configured to releasably grip a container, and a drive mechanism configured to raise and lower the grabber device;
b) a wheel assembly comprising a first set of wheels for engaging with the first set of grid members to guide movement of the load handling device in a first direction and a second set of wheels for engaging with the second set of grid members to guide the movement of the load handling device in a second direction, wherein the second direction is transverse to the first direction;
c) a wheel positioning mechanism configured for selectively lowering or raising the first set of wheels or the second set of wheels into engagement or disengagement with the first set of grid members or the second set of grid members;
d) electrical components comprising a processor for controlling the container lifting mechanism and wheel positioning mechanism;
e) a power source for powering electrical components, wherein the power source is connected to the electrical components by cabling;

wherein the load handling device further comprises:

a cable router for routing cabling from the power source to the electrical components;

wherein the cable router comprises:
a spine, the spine comprises two opposing longitudinal members; and
a plurality of ribs spaced apart from each other along the spine and connecting the two longitudinal members, the spine and the ribs providing a space for receiving the cabling;
wherein the longitudinal members have a width extending in a plane transverse to the longitudinal direction of the spine, and the width of the longitudinal members inhibits the cable router from bending in the plane in which the width extends.

The cable router therefore inhibits the cable from moving outside the footprint of the load handling device to prevent interactions with adjacent load handling devices. It may also prevent the cabling from getting caught in any moving parts of the load handling device.

Optionally, the cable router may be attachable to any one of the container lifting mechanism, the wheel assembly, the wheel positioning mechanism or the electrical components. The cable router may be attachable by a fastener, such as a clip, a hook etc.

Optionally, the load handling device may further comprise at least four connecting blocks, each of the at least four connecting blocks being connected to two other connecting blocks in a single modular section by one or more substantially horizontally connecting elements to form a rectangular frame, wherein the cable router is configured to route cabling from one of the at least four connecting blocks to any one of the container lifting mechanism, the wheel assembly, the wheel positioning mechanism, the electrical components or a second of the at least four connecting blocks. Thus the cable router can bridge a gap between a fixed connecting block to a moving part and allow controlled movement of the cable.

The cable router of the load handling device may comprise any of the features described above.

An automated storage and retrieval system is provided. The system comprises a grid structure comprising a plurality of grid members comprising a first set of grid members and a second set of grid members, the second set of grid members being substantially perpendicular to the first set of grid members such that the plurality of grid members are arranged in a grid pattern for guiding the movement of one or more the load handling devices operating on the grid structure; and at least one load handling device comprising any of the features described above.

A cable retainer is provided. The cable retainer may be a combination of the grooves in the body portion of the component and a cable router as described above. The cable retainer may be understood as being a system for routing and retaining cables in a device, such as a load handling device. The cable router may be attachable to the one or more grooves of the component to define an elongated channel extending from the component to a free end of the spine of the cable router. The cable router may be attached to the one or more grooves by a fastener, such as a clip, or hook. The cable retainer may provide fixed retention of a cable within a fixed component and the ability to route the cable away from the component and allow it to flex in a particular direction dependent on the orientation of the spine. In particular, the cable retainer may allow the cable to be routed around a fixed component and to a moving component, such as a container lifting mechanism, a wheel assembly, a wheel positioning mechanism etc. The cable retainer may allow easy maintenance of the device because the cables may be fully accessible and may be removed and re-fitted easily. The cable retainer may comprise any of the features of the component and/or cable router described above.

### DESCRIPTION OF DRAWINGS

These and other aspects of the invention will now be described, by way of example only, and with reference to the accompanying drawings, in which:

FIG. 1 is a schematic diagram of a grid framework structure.

FIG. 2 is a schematic diagram of a top down view showing a stack of bins arranged within the framework structure of FIG. 1.

FIG. 3 is a schematic diagram of a load handling device operating on the grid framework structure.

FIG. 4 is a schematic perspective view of the load handling device showing the lifting device gripping a container from above.

FIG. 5(a) and 5(b) are schematic perspective cut away views of the load handling device of FIG. 4 showing (a) a container accommodated within the container receiving space of the load handling device and (b) the container receiving space of the load handling device.

FIG. 6 is a schematic drawing of an assembly of the modular sections to form an open frame structure of the load handling device.

FIG. 7 is a schematic perspective view of a component for a load handling device.

FIG. 8 is a schematic perspective view of a portion of a component for a load handling device (a) without any cabling and (b) with cabling.

FIG. 9 is a schematic perspective view of a cable being routed through a component for a load handling device.

FIG. 10 is a schematic perspective view of a clip for retaining the cable within a groove in the body portion of the component.

FIG. 11 illustrates the clip of FIG. 10 positioned in a groove and retaining a cable within the groove.

FIG. 12(a) and 12(b) illustrate a push-fit mechanism for inserting an overmoulded section of a cable into the groove.

FIG. 13 is a cross-sectional profile showing the overmoulded section of the cable in the groove of FIG. 12.

FIG. 14(a), 14(b), and 14(c) illustrate a twist-fit mechanism for inserting an overmoulded section of a cable into the groove.

FIG. 15 shows a cable having multiple overmoulded sections.

FIG. 16 illustrates different perspective views of a cable router. FIG. 16(a) illustrates a perspective view of the cable router, FIG. 16(b) illustrates a side view of a portion of the cable router of FIG. 16(a) and FIG. 16(c) illustrates the cross-sectional profile of sections A-A, B-B and C-C shown in FIG. 16(a) and (b).

FIG. 17 shows a cable retainer (system) comprising a component comprising a groove for retaining a cable therein attached to the cable router of FIG. 16.

FIG. 18(a) and 18(b) show how the cable router flexes when attached between a fixed and a moving component.

FIG. 19 shows a further embodiment of a cable router. FIG. 19(a) illustrates a perspective view of the cable router, FIG. 19(b) illustrates a top view of the cable router, FIG. 19(c) illustrates the cross-sectional profile of sections A-A, B-B and C-C.

FIG. 20 shows a bottom perspective view of the cable router of FIG. 19 with various cable retaining mechanisms.

FIG. 21 shows a perspective view of one type of cable retaining mechanism.

FIG. 22 shows the cable router of FIG. 19 arranged between a fixed component and a moveable component.

FIG. 23 shows how the cable router of FIG. 19 flexes when attached between a fixed and a moving component. FIG. 23(a) shows the cable router in a first configuration. FIG. 23(b) shows the cable router in a second configuration.

In the figures, like features are denoted by like reference signs where appropriate.

### DETAILED DESCRIPTION

The following embodiments represent preferred examples of how the invention may be practised, but they are not necessarily the only examples of how this could be achieve. These examples are described in sufficient detail to enable those skilled in the art to practise the invention. Other examples may be utilised and structural changes may be made without departing from the scope of the invention as defined in the appended claims. Moreover, direction references and any other terms having an implied orientation are given by way of example to aid the reader's understanding of the particular examples described herein. They should not be read to be requirements or limitations, particularly as to the position, orientation, or use of the invention unless specifically set forth in the appended claims. Similarly, connection references (e.g., attached, coupled, connected, joined, secured, and the like) are to be construed broadly and may include intermediate members between a connection of elements and relative movement between elements. As such, connection references do not necessarily infer that two elements are directly connected and in fixed relation to each other, unless specifically set forth in the appended claims. Similarly, wording such as “movement in the n-direction” and any comparable wording, where n is one of x, y, or z, is intended to mean movement substantially along or parallel to the n-axis in either direction (i.e. towards the positive end of the n-axis or towards the negative end of the n-axis).

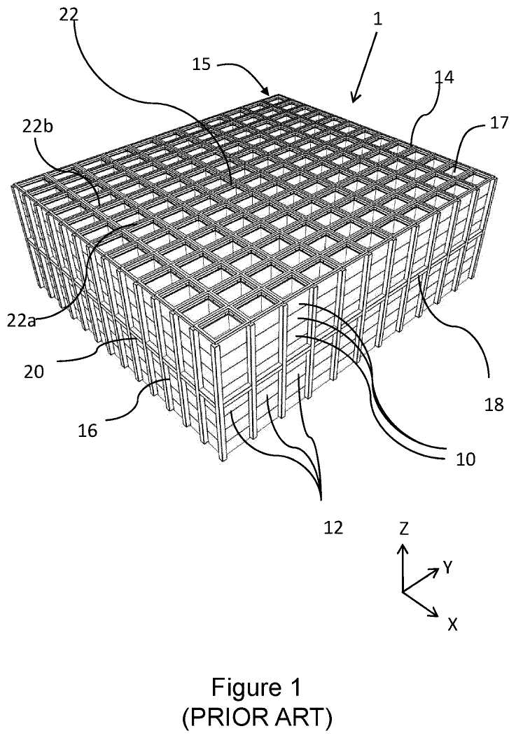

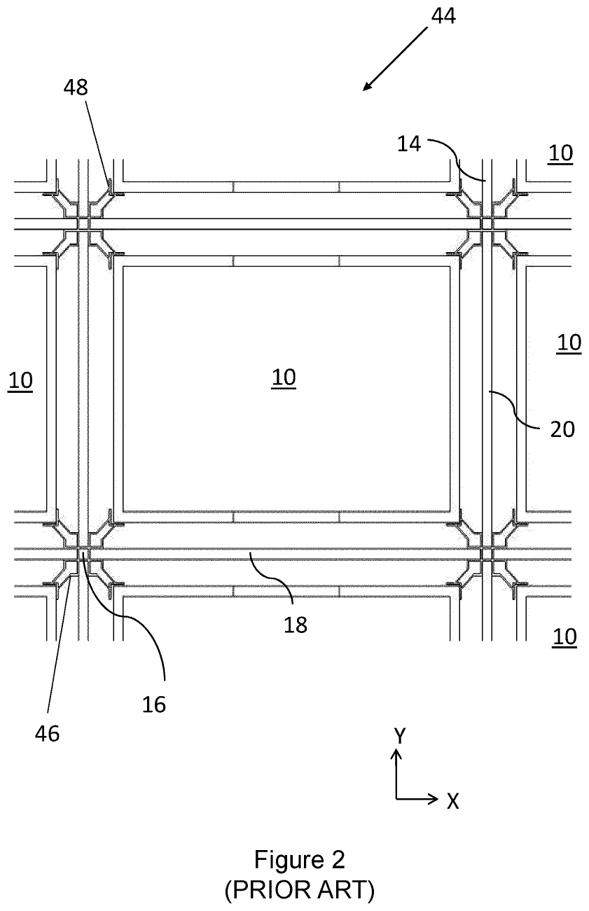

FIGS. 1 to 3 of the accompanying drawings illustrate a storage and retrieval system. As shown in FIGS. 1 and 2, stackable containers, known as storage bins or containers 10, are stacked on top of one another to form stacks 12. The stacks 12 are arranged in a three dimensional grid framework structure 14 in a warehousing or manufacturing environment. The grid framework structure is made up of a plurality of storage columns or grid columns. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application. Bins 10 may also be referred to as storage bins or containers or storage containers or totes.

The grid framework structure comprises a supporting framework structure, upon which is mounted a track system for supporting the load handling devices. In the particular example of a grid framework structure illustrated in FIGS. 1 to 3, the supporting framework structure 14 comprises a plurality of vertical uprights or upright members or upright columns 16 that support horizontal grid members 18, 20. A first set of parallel horizontal grid members 18 is arranged perpendicularly to a second set of parallel horizontal grid members 20 to form a grid structure or grid 15 comprising a plurality of grid cells 17. The grid cell has an opening to allow a load handling device to lift a container or storage bin through the grid cell. In the grid structure, the first set of parallel horizontal grid members 18 intersect the second set of parallel horizontal grid members at nodes. The grid structure 15 is supported by the upright members 16 at each of the nodes or at the point where the grid members intersect such that the upright members are interconnected at their tops ends by the intersecting grid members. The grid members 16, 18, 20 are typically manufactured from metal and typically welded or bolted together or a combination of both. The storage bins or containers 10 are stacked between the upright members 16 of the grid framework structure 14, so that the upright members 16 guard against horizontal movement of the stacks 12 of bins 10, and guide vertical movement of the storage bins 10.

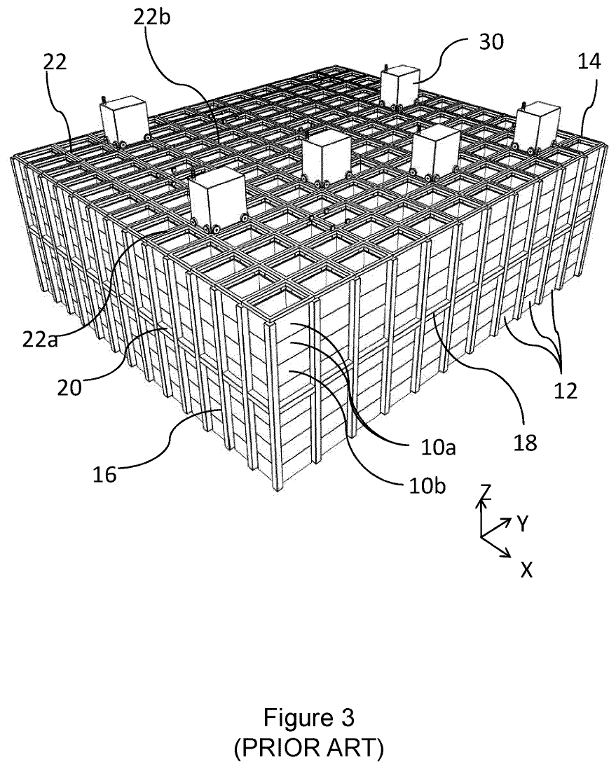

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

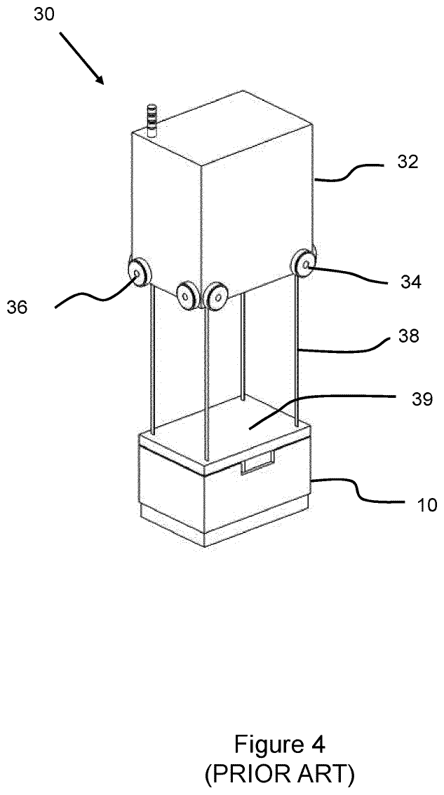

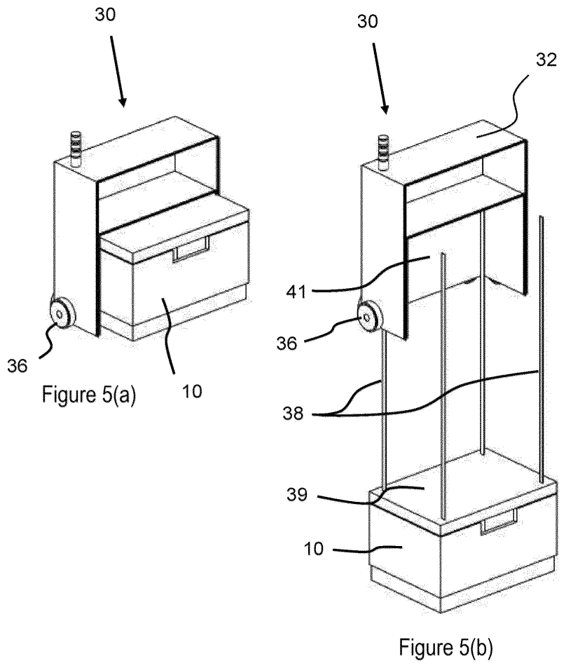

A load handling device or robotic load handling device otherwise known as a bot 30 shown in FIGS. 4 and 5 comprising a vehicle body 32 is described in PCT Patent Publication No. WO2015/019055 (Ocado Innovation Limited), hereby incorporated by reference, where each load handling device 30 only covers a single grid space or grid cell of the grid framework structure 14. Here, the load handling device 30 comprises a wheel assembly comprising a first set of wheels 34 consisting of a pair of wheels on the front of the vehicle body 32 and a pair of wheels 34 on the back of the vehicle 32 for engaging with the first set of rails or tracks to guide movement of the device in a first direction, and a second set of wheels 36 consisting of a pair of wheels 36 on each side of the vehicle 32 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the grid structure.

WO2017/153583 (Ocado Innovation Limited) teaches a load handling device comprising a wheel positioning mechanism or directional change mechanism for enabling lateral movement of the device in one of two transverse directions by enabling either a first or second set of wheels to selectively engage the first or second set of rails or tracks (22a or 22b). The wheel positioning mechanism comprises a complicated arrangement of linkages driven by a linear actuator or motor to selectively lower or raise the first set of wheels or the second set of wheels into engagement or disengagement with the first set of tracks or rails or the second set of tracks or rails.

The load handling device 30 is equipped with a lifting mechanism or container lifting mechanism or crane mechanism to lift a storage container from above. The crane mechanism comprises a winch tether or cable 38 wound on a spool or reel (not shown) and a grabber device 39 in the form of a lifting frame. The lifting device comprise a set of lifting tethers 38 extending in a vertical direction and connected nearby or at the four corners of the lifting frame 39, otherwise known as the grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess 41, in the lower part. The recess is sized to accommodate the container 10 when it is lifted by the crane mechanism, as shown in FIG. 5 (a and b). When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS), in which case the container receiving space is located below a cantilever of the load handing device. In this case, the grabber device is hoisted by a cantilever such that the grabber device is able to engage and lift a container from a stack into a container receiving space below the cantilever.

Typically, the load handling device comprises one or more electrical components such as a rechargeable power source to provide power to the drive units for operating the lifting mechanism and the wheel positioning mechanism and a control unit. For example, one or more load handling devices remotely operable on the grid structure are configured to receive instructions from a master controller to retrieve a storage container from a particular a storage location within the grid framework structure. Wireless communications and networks may be used to provide the communication infrastructure from the master controller via one or more base stations to the one or more load handling devices operative on the grid structure. A controller in the load handling device in response to receiving the instructions is configured to control various driving mechanisms to control the movement of the load handling device. For example, the load handling device may be instructed to retrieve a container from a storage column at a particular location on the grid structure. The instruction can include various movements in an X-Y direction on the grid structure. Once at the storage column, the lifting mechanism is then operated to grab the storage container and lift it into a container receiving space in the body of the load handling device where it is subsequently transported to a another location on the grid structure commonly known as a drop off port. The container is lowered to a suitable pick station allow retrieval of the item from the storage container. Movement of the load handling devices on the grid structure also involves the load handling devices being instructed to move to a charging station which is usually located at the periphery of the grid structure. The electrical components of the load handling device are typically housed within the body of the load handling device.

The specific example of a load handling device illustrated in FIGS. 4 and 5 shows the load handling device 30 with a body that is substantially box-shaped with four sidewalls and a top wall, with the components of the load handling device housed within the body. In other examples the body may comprise an open frame or skeleton structure 42, within or upon which components of the load handling device 30 are supported. The open frame structure 42 comprises modular sections 44 formed by connecting or linking together connecting blocks 43.

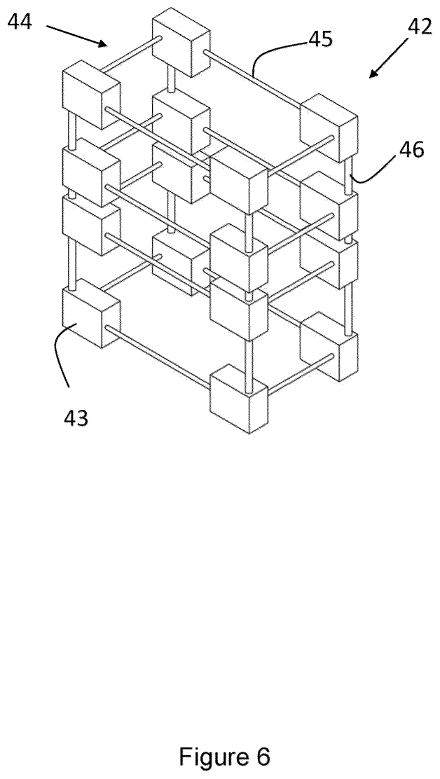

The different modular sections 44 of the load handling device 30 can be envisaged by a simplified modular block construction forming a vertically stacked, layered structure shown in FIG. 6. Four modular sections 44 are shown in a vertical stack, each of the four modular sections 44 providing one or more of the functional characteristics of the load handling device 30. Each modular section 44 carries at least a portion of one or more of the functional components of the load handling device 30. The number and position of the different modular sections 44 within the layered structure is not limited to four modular sections 44 shown in FIG. 6, and includes any number of modular sections 44 providing additional functional characteristics of the load handling device 30 or can be shared amongst any number of modular sections 44.

Each modular section 44 can be envisaged as a rectangular open frame 44 formed by connecting or linking together corner brackets, where each corner bracket is shown as a connecting block 43 in FIG. 6. A modular section 44 is built by connecting adjacent connecting blocks 43 in the same horizontal plane by one or more horizontal connecting elements 45 to form an open rectangular frame 44. Vertically adjacent rectangular frames are thus connected together by connecting vertically adjacent connecting blocks 43 to form the open frame structure 42. An example of a connecting block 43 is a corner bracket. In a singular modular section 44, each corner bracket 43 is connected to two other corner brackets 43 in the same horizontal plane by one or more horizontal connecting elements 45. The connecting elements 45 can be connecting rods or tubes for linking adjacent connecting blocks (corner brackets) 43 together in a single modular section 44. The connecting rods can be solid or hollow.

A simplified modular section 44 is where the connecting block 43 is a corner bracket such that a modular section 44 comprises four corner brackets 43. Each of the four corner brackets 43 is directly connected to two other corner brackets 43 in the same horizontal plane to form a simple open rectangular frame as shown in FIG. 6. However, the corner brackets 43 in a single modular section 44 can be indirectly connected to two other corner brackets 43 by one or more connecting blocks intermediate of the corner brackets 43 at the corners of the rectangular frame. Thus, the term “connected” with reference to the corner brackets 43 in each of the modular sections 44 can be broadly construed to mean directly and/or indirectly connected to two other corner brackets 43.

To construct the load handling device 30 according to the present invention, the different modular sections 44 can be linked together by simply linking vertically adjacent rectangular frames 44 together by one or more vertical connecting elements 46 via their respective corner brackets 43 to form an open frame structure 42 as shown in FIG. 6. In other words, the same corner brackets 43 for connecting to two other corner brackets 43 in a single modular section 44 can be used to vertically connect adjacent rectangular frames 44 together. The corner brackets 43 of vertically adjacent rectangular frames 44 can be mounted to the same vertical connecting element 46 at each corner of the open frame structure 42 such that the vertical connecting element 46 extends though the corner brackets 43 of multiple vertically adjacent rectangular frames. As a result, each of the corners of the open frame structure 42 share the same or common vertical connecting element 46. To link multiple rectangular frames to the same vertical connecting element 46 at each corner of the open frame structure 42 via their respective corner brackets 43, the corner brackets intermediate or between the bottom and top rectangular frames 44 have one or more through holes for the vertical connecting elements 46 to extend through the corner brackets 43 when linking together vertically adjacent rectangular frames 44. This has the advantage that multiple rectangular frames 44 can be vertically linked together in a stack simply by mounting the multiple rectangular frames 44 to the same vertical connecting element 46 at each corner of the open frame structure 42 to form the load handling device 30. Alternatively, separate vertical connecting elements 46 can be used to connect vertically adjacent rectangular frames at each corner of the open frame structure 42. The length of the vertical connecting elements 46 connecting vertically adjacent rectangular frames dictates the height of the load handling device 30. The connecting elements 46 linking vertically adjacent rectangular frames together can be same type or different type of connecting elements to the horizontal connecting elements 45 linking adjacent corner brackets 43 in the same horizontal plane.

To simplify the construction of the load handling device 30 whilst still accommodating the different functional characteristics of the load handling device 30, at least a portion of the functional components of the load handling device 30 is integrated into the open frame structure 42 of the load handling device 30, in the sense that at least a portion of the functional components of the load handling device 30 are integral with one or more of the rectangular frames 44 of the load handling device 30. For example, at least a portion of the wheel assembly is integral with one or more rectangular frames 44, at least a portion of the wheel drive assembly is integral with one or more rectangular frames, at least a portion of the wheel positioning mechanism is integral with the one or more rectangular frames 44 and/or at least a portion of the container lifting mechanism is integral with one or more rectangular frames 44.

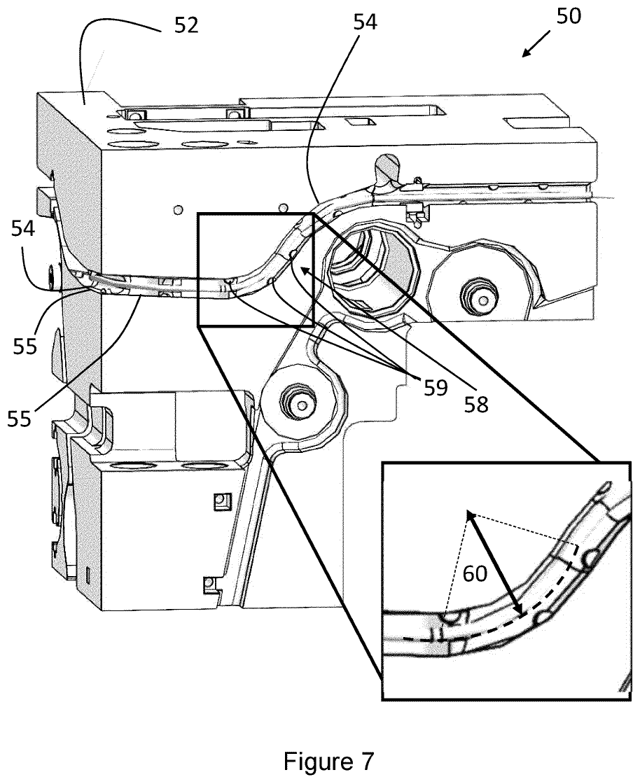

FIG. 7 illustrates a component 50 for a load handling device 30 with open frame structure construction. The component 50 acts as a connecting block 43 in a modular section 44 of the open frame structure 42 of the load handling device 30. In the illustrated example, the component 50 is a corner bracket 43 of the open frame structure 42 of the load handling device 30. Four of the components 50 can be connected with horizontal connecting elements 45 (not shown) to form a substantially horizontal modular section or rectangular open frame 44.

The component 50 comprises a body portion 52. The body portion 52 forms the physical structure of the component. Within the body portion 52 is a groove 54, running along the front and left side of the body portion 52 as shown in FIG. 7. The groove 54 defines an elongated channel 55 which forms part of and is integral with the body portion 52. The groove 54 is a depression within the body portion of the component. In FIG. 7 the grooves comprise a C-shaped cross-sectional profile which is open on the outside of the component 50 so that a cable can easily be inserted or removed. A cable is routed along the groove 54, and the groove 54 acts to guide the cable 56 through the body portion 52.

A cable retaining mechanism 58 is provided to retain the cable (not shown) within the groove 54. In the illustrated example the cable retaining mechanism 58 takes the form of tabs or protrusions 59 within the groove 54 and integral with the groove 54. The tabs 59 retain the cable within the groove 54 when in use. The tabs also facilitate easy removal of the cable from the groove 54; the cable can easily be pulled out of the groove 54 past the tabs 59. In the illustrated example, the tabs 59 are spaced out along the groove 54, and arranged on alternate sides of the groove. This alternate arrangement of the tabs 59 means that the cable is more securely retained within the groove as a result of being held in place on both sides of the groove by the tabs.

In the example illustrated in FIG. 7, the groove 54 is curved, and therefore guides a cable in a curved path. Each bend in the path of the groove 54 has a bend radius 60, as illustrated in the inset diagram of FIG. 7. The bend radius 60 of the groove 54 is defined to not exceed a pre-defined minimum bend radius characteristic of the cable. In other examples, some of the grooves 54 may be straight and others may be curved. In examples where two or more of the grooves are curved, the curved grooves may have the same bend radius 60 or different bend radii. The bend radius 60 of the groove not exceeding a pre-defined minimum bend radius characteristic of the cable is important because exceeding the pre-defined bend radius could cause damage to the cable.

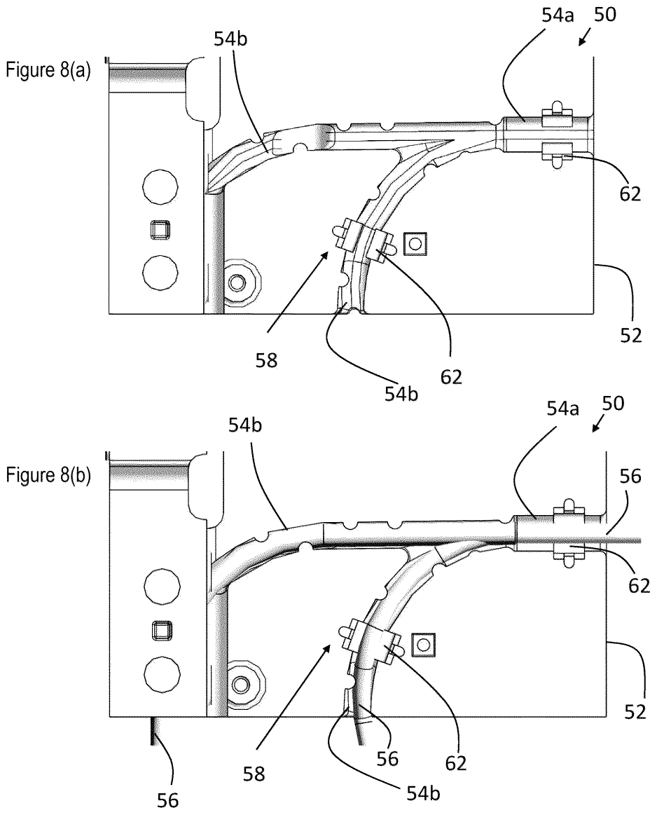

FIG. 8 (a and b) illustrates a portion of a component with grooves 54 for routing cables. In this particular illustrated example, a straight groove 54a on the right of the figure diverges into two curved grooves 54b. This arrangement is useful in cases where cabling is required to connect the power source of the load handling device 30 to multiple electronic components in different locations on the load handling device 30. The optimal paths for the cabling from the power source to different electronic components may partially fall along the same path, or be close enough that part of the path can be combined so that it can be guided by a single groove 54a. Combining two cable paths into a single path has the advantage that a single groove 54a may be provided to route two cables 56, which permits the component to have a simpler construction. When there are two cables routed along a single groove, it may be particularly useful for the groove to have a W-shaped cross-sectional profile (not shown), so that each cable can rest in the base of each of the V-shapes of the W-shaped cross-sectional profile. FIG. 8(a) illustrates the component 50 and grooves 54a, 54b without cables, and FIG. 8(b) illustrates the same component 50 with the cables 56 present. The width of the groove is specially chosen to suit the cable to be retained in the body portion. As shown in FIG. 8(b), the cable 56 fits exactly into the width of the groove.

In the illustrated example in FIG. 8, the cable retaining mechanism 58 further comprises clips 62, in addition to the tabs 59 discussed earlier. The clips 62 engage with the grooves 54a, 54b and retain the cables 56 in the grooves 54a, 54b. For example, the clips 62 can engage with the grooves 54 with a snap-fit engagement. Snap-fit engagement has the advantage of being easy and convenient to engage or disengage the clips, so if the cables 56 need to be removed for maintenance this can be done quickly and efficiently.

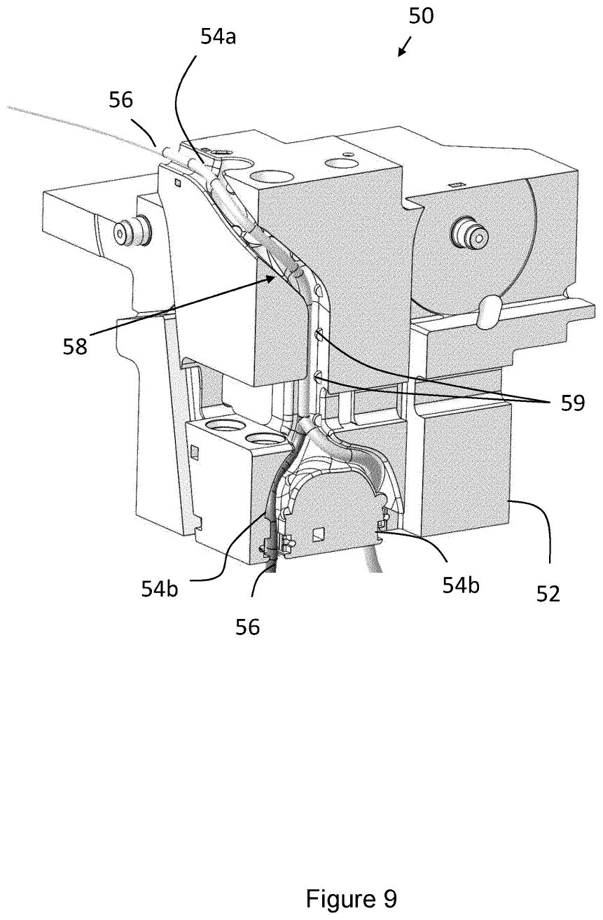

FIG. 9 illustrates another example of a component 50 with grooves 54 for directing cables. As in the example of FIG. 8, a single groove 54a diverges into two grooves 54b. The single groove runs from the top of the component 50, and splits into two grooves 54b towards the bottom of the component 50. The path of the grooves 54 in this example is somewhat tortuous, routed around functional components. The path of the grooves 54 can be determined by other requirements, e.g. the location of functional components of the load handling device 30 and the requirement not to obstruct moving parts.

In the example illustrated in FIG. 9, the cable retaining mechanism 58 comprises a plurality of tabs 59 on the outside of the grooves 54. The tabs are spaced out along the grooves. In certain parts of the grooves the tabs are arranged alternately on opposite sides of the grooves 54 to enable easy removal and insertion of the cable 56.

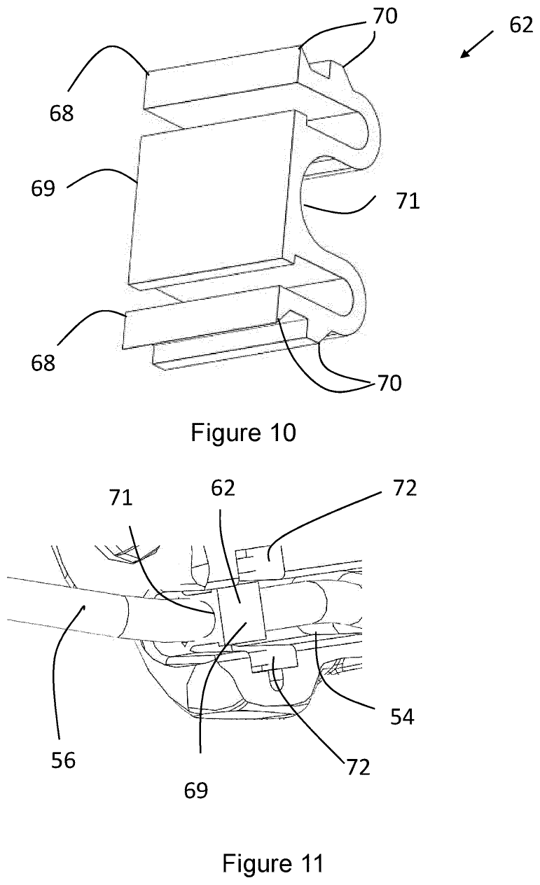

FIG. 10 illustrates an example of a cable retaining mechanism. A clip 62 (also shown in FIG. 8) comprises a centre portion 69 and two flexural arms 68 disposed on either side of the centre portion 69. The flexural arms 68 are integral with the main body of the clip 62, and can flex relative to the centre portion of the clip 62. The flexural arms 68 of the clip 62 can engage with the sides of the groove 54. The flexural arms 68 are provided with ridges or protrusions 70, which can engage with locating features in the groove. When in the groove, the flexural arms 68 push outwards against the sides of the groove 54 so that the ridges are pressed into the locating features. To remove the clip 62 from the groove, the two flexural arms 68 are squeezed together so that the flexural arms 68 move inwards towards the centre portion 69 and the ridges 70 on the flexural arms 68 are removed from the locating features. The clip 62 can then be removed from the groove. The centre portion has an interior arcuate shape 71 to accommodate a cable.

FIG. 11 is a close-up view of a cable 56 being retained in a groove 54 by the clip 62 show in FIG. 10. The groove comprises a pair of locating features 72 which are positioned opposite each other across the width of the groove. The locating features 72 are sized and shaped to accommodate the flexural arms 68 of the clip 62. When the cable 56 is positioned in the groove 54, the flexural arms 68 of the clip 62 can be squeezed together, and the clip can be positioned such that the interior arcuate shape 71 of the centre portion 69 of the clip saddles the cable 56. Then the flexural arms 68 of the clip 62 can be released into the locating features 72 of the groove such that the clip 62 is retained in the groove 54, and the cable 56 is retained in the groove 54. The flexural arms 68 push down on the cable 56 such that cable is firmly held in the groove 54.

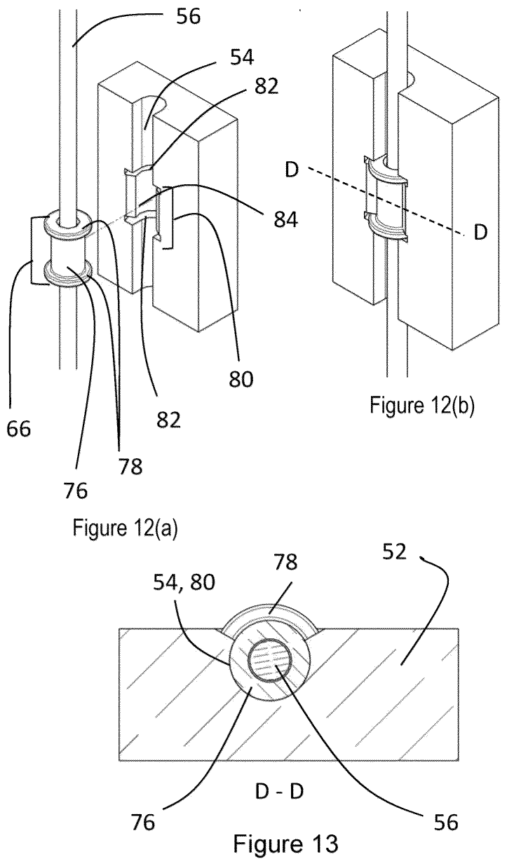

Another cable retaining mechanism is shown in FIGS. 12 and 13. A portion 80 of the groove 54 is configured to receive an overmoulded cable or overmoulded section 66 of cable. The overmoulded section 66 of the cable 56 is formed by placing the cable 56 into a mould, molten plastic material is injected into the mould cavity and once the plastic material cools and solidifies, the plastic material conforms to the shape of the mould and thus an overmoulded section 66 is formed around the cable 56. In FIG. 12 the overmoulded section 66 of the cable 56 has a bobbin-like shape which comprises a central part 76 and two circular rims 78 at either end of the overmoulded section 66. The central part 76 of the overmoulded section 66 has a larger diameter and circumference than the diameter and circumference of the cable 56, and the two circular rims 78 are located on either side of the central part 76. The portion 80 of the groove 54 has a shape complementary with the shape of the overmoulded section such that the overmoulded section 66 of the cable 56 can be pushed into the portion 80 of the groove 54 and be retained in the groove, as shown in FIG. 12(b). The shape of the portion 80 of the groove therefore comprises two circular slots 82 on either side of a central part 84. The circular rims 78 of the overmoulded section 66 of the cable 56 fit into the annular slots 82 of the portion 80 of the groove 54, and the central part 76 of the overmoulded section 66 of the cable 56 fits into the central part 84 of the portion 80 of the groove 54. In particular, the rims 78 of the overmoulded section 66 which fit into the portion 80 of the groove 54 prevent the cable 54 from moving longitudinally along the length of the groove 54. This is because the rims 78 of the overmoulded section fit into the two circular slots 82 in the portion 80 of the groove 54 and the two circular slots 82 wrap around the rims 78 such that the cable cannot move in either direction along the length of the groove 54. The overmoulded section 66 of the cable 56 is fitted into the portion 80 of the groove 54 by a push-fit mechanism.

FIG. 13 shows a cross-sectional profile at the plane marked D-D in FIG. 12(b) of the overmoulded section 66 of the cable positioned in the groove 54. The central section 76 of the overmoulded section 66 surrounds the cable 56 and fills the portion 80 of the groove 54. A circular rim 78 of the overmoulded section 66 is shown obstructed from moving along the length of the groove 54 by the body portion 52 of the component, and in particular the annular slot 82 of the portion 80 of the groove 54. The shape of the overmoulded section 66 is not restricted to being a bobbin-shape. Instead, the overmoulded section may be square-shaped, star-shaped or have any other suitable shape, and the portion 80 of the groove 54 has a shape complementary to the overmoulded section so that the overmoulded section can have a push-fit arrangement with the portion 80 of the groove 54 and so the overmoulded section is retained in the groove 54. Alternatively, the cable may comprise grommets, and the portion of the groove may be shaped to fit the cable and grommets such that the cable cannot move along the length of the groove. Specifically, the grommets act in the same way as the circular rim 78 of the overmoulded section 66 of the cable such that circular slots 82 in the groove wrap around the grommets.

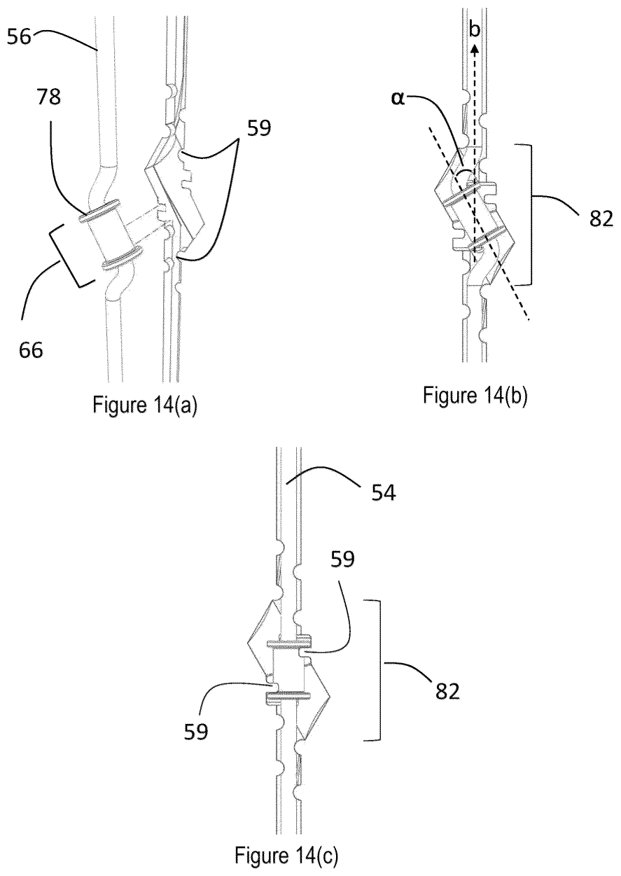

Another cable retaining mechanism is shown in FIG. 14. The cable retaining mechanism comprises tabs 59 arranged along the length of the groove 54 and a portion 82 of the groove is configured to engage with the overmoulded section 66 of the cable 56. The portion 82 of the groove 54 in the present cable retaining mechanism is shaped to allow the overmoulded section 66 of the cable 56 to be pushed into the portion of the groove and rotated in the portion of the groove. FIG. 14 (a) to (c) show how the overmoulded section 66 of the cable 56 is positioned and retained within the groove 54. First, the overmoulded section is pushed into the portion 82 of the groove 54 at an angle α to the direction b of the length of the groove (as shown in FIG. 14(a) and FIG. 14(b)). Specifically, the portion of the groove is shaped to allow the overmoulded section 66 to be pushed in at an acute angle α to the direction b of the length of the groove. The direction b of the length of the groove is also termed the longitudinal direction of the groove. For example, the angle α may be between 1° and 5°, or between 5° and 10° or between 10° and 15°, or between 15° and 200, or between 20° and 25°, or between 25°and 30°, or between 30° and 35°, or between 35° and 40°, or between 40° and 45° to the direction b of the length of the groove. The tabs 59 are arranged along the sides of the portion 82 of the groove such that the tabs do not engage with the overmoulded section 66 as the overmoulded section is inserted into the portion of the groove. When the overmoulded section 66 is positioned in the portion of the groove 82 as shown in FIG. 14(b), the cable is under high stress. In order for the cable to reach a preferred lower stress position, the portion of the cable is rotated either anti-clockwise or clockwise through the angle α towards the longitudinal direction b, resulting in the overmoulded section of the cable being aligned with the direction b of the length of the groove. The overmoulded section 66 is rotated clockwise from the position shown in FIG. 14(b) to the position shown in FIG. 14(c). When the overmoulded section 66 of the cable 56 is positioned in line with the length of the groove as shown in FIG. 14(c), the tabs 59 arranged on either side of the groove keep the overmoulded section 66 from falling out of the groove 54 or moving axially.

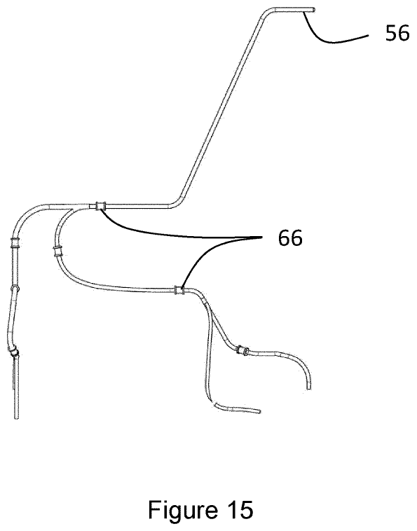

There can be many overmoulded sections 66 positioned along the length of the cable 56, as shown in FIG. 15. Each of these will have an associated portion 80, 82 of a groove 54 into which the overmoulded sections 66 fit. Additionally, the cable comprising overmoulded sections 66 may be held in place in a groove by tabs 59 as shown in FIGS. 8 and 9 for example. Additionally or alternatively, the overmoulded sections 66 of the cable 56 may be held in place in a portion 80, 82 of a groove by a clip, for example the clip 62 shown in FIG. 10.

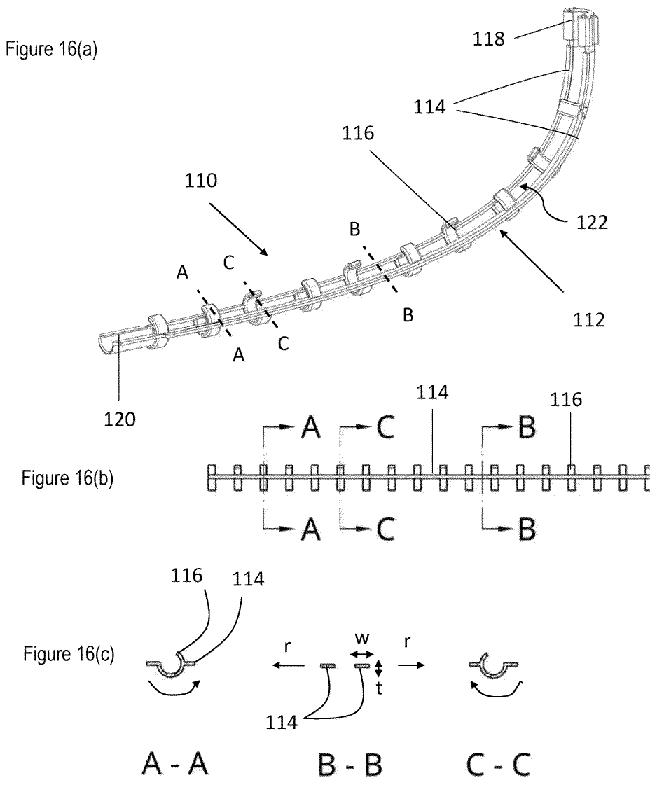

FIG. 16 illustrates a flexible cable router 110. The cable router is designed to bridge a gap between two components, for example in load handling device. In particular, the cable router may be used to bridge a gap between a fixed component and a moving part, or two moving parts because of the flexibility of the cable router. Whilst held by the cable router, the cable is allowed to bend in specific directions as a result of the structure of the cable router. The cable router 110 comprises a spine 112 which provides the structural backbone of the cable router and controls the bend of the cable router, and several ribs 116 which are positioned along the length of the spine. The space between the ribs 116 and the spine creates a space 122 for receiving a cable, otherwise termed a ‘cable receiving space’. The spine 112 comprises two opposing longitudinal members 114 which extend along the (longitudinal) length of the spine. The longitudinal members are spaced apart by ribs 116 which are located at regular intervals along the length of the spine. The space between the longitudinal members and the ribs creates a cable receiving space. Specifically there are 10 ribs shown in the cable router in FIG. 16(a), but there could be any number of ribs dependent on the length of the cable router, for example, there could be between (and including) 1 and 5 ribs, or between (and including) 5 and 10 ribs, or between (and including) 10 and 15 ribs, or between (and including) 15 to 20 ribs. The ribs 116 act as bridging elements bridging a gap between the two longitudinal members. Thus, the positioning of the ribs determines how far apart the longitudinal members are from each other. This means that the cable router can be made to suit a particular cable. In FIG. 16 the ribs are shown as being C-shaped. Each rib has an opening 116 to allow a cable to be pushed under the rib. The ribs do not necessarily have to be C-shaped, for example, they could have a square shape. However, the C-shape is particularly advantageous because a C-shaped rib cradles the cable so the cable is held firmly in the cable router. The ribs are arranged in pairs such that in each pair of ribs, one of the ribs extends anticlockwise from a longitudinal member (see A-A in FIG. 16(c)) and one of the ribs extends clockwise from an opposing longitudinal member (see C-C in FIG. 16(c)). Thus, in this configuration, the cable is supported from both sides by a pair of ribs. Aside from the ribs, bridging between the longitudinal members is also provided by a fastener in the form of a clip 118 on one end of the cable router and a cable guide 120 at the other end of the cable router. The clip 118 shown in FIG. 16(a) is similar in size, shape and configuration with the clip shown in FIG. 10. In particular, the clip comprises a pair of flexible arms extending orthogonal to the length of the spine. Alternatively, the clip 118 can comprise a single flexible arm which extends along the longitudinal length of the spine which is configured to interlock with a complementary shape in or near the groove of the component. The cable guide 120 can slot into a groove in a moving part or in a fixed component, or the cable guide can be fastened by another mechanism, e.g. by a hook, to another fixed component or moving part. Both the clip 118 and the cable guide 120 have continuous surfaces which support either ends of the cable in the cable router 110.

The cable router 110 is 3D printed and is initially printed in a curved shape, as shown in FIG. 16(a). The curved shape extends in a longitudinal direction/along the length of the spine. As shown in FIG. 16(a), the cable router is bent into a C-shape along the length of the spine. By 3D printing the cable router in a curved shape, the cable router has a rest or preferred state in a curved shape, as shown in FIG. 16(a). This is particularly useful because the stresses in the cable router are minimised. Further, the amount of bending that is required by the cable router is minimised because the cable router is already bent. The cable router could alternatively be printed in a different curved shape to the one shown in FIG. 16(a), for example, the cable router may be 3D printed in an S-shape to route the cable around various features in a load handling device.

The cable router 110 shown in FIG. 16 comprises a lot of open space. This is because for the majority of the length of the cable router, the only feature retaining a cable within the cable router is the spine 112. Specifically in FIG. 16, the spine 112 does not comprise a continuous surface between the two longitudinal members 114, but the cable router may be constructed comprising a continuous surface if desired. Further, the ribs 116 are spaced apart along the length of the spine 112. Thus, the cross-sectional profile of the cable router 110 varies along the length of the cable router. This is shown in FIG. 16(c). Slice A-A is taken across a rib 116 and two longitudinal members 114. In this case, the cross-sectional profile of the cable router is substantially circular and the rib 116 extends in an anti-clockwise direction. Similarly, slice C-C is taken across a rib 116 and two longitudinal members 114. In this case, the cross-sectional profile of the cable router is substantially circular but the rib extends in a clockwise direction. Slice B-B is taken across just the spine 112 of the cable router (no ribs are included in the slice) and the slice shows the cross-sectional area of the longitudinal members. Specifically, the width w of the longitudinal members 114 is clearly shown and the width extends outwardly from the cable router. The width w is greater than the thickness t of the longitudinal members and so there is rigidity in the longitudinal members 114 in the direction shown by the arrows r, as indicated in FIG. 16(c). This means that the cable router 110 cannot bend in the directions shown by the arrows r. As the thickness t of the longitudinal members 114 is small, the cable router can bend in a direction perpendicular to the directions shown by the arrows r, i.e. the cable router can bend or flex vertically. Thus, the cable router is restricted in the direction in which it bends. When fitting the cable router to a device, the spine 112 can be orientated such that the longitudinal members 114 inhibits bending of the cable router (and therefore the cabling) in, for example, a vertical or a horizontal direction.

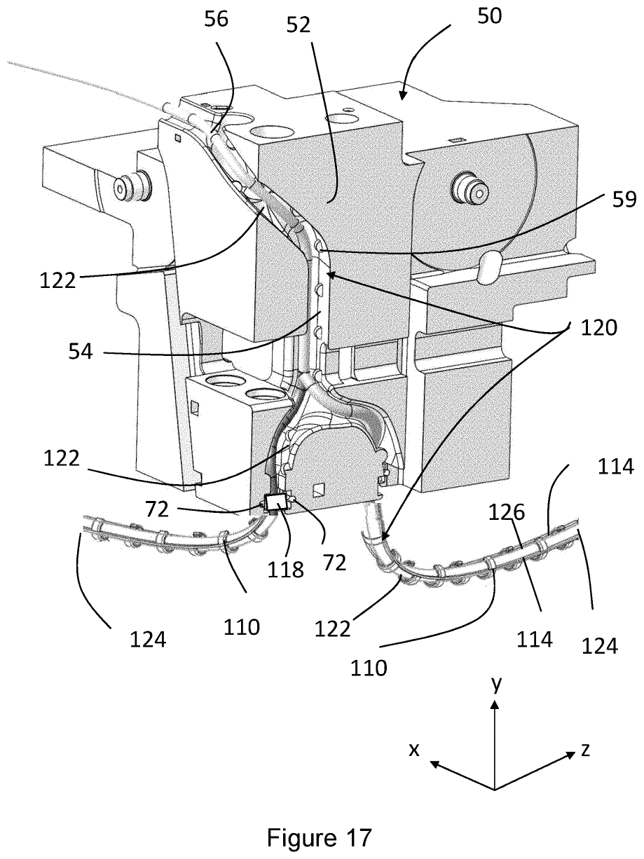

FIG. 17 shows a combination of the grooves 54 in a component 50 shown in FIGS. 7 to 9 with two flexible cable routers previously shown in FIG. 16. The combination of a flexible cable router and a component comprising grooves as described above is termed a cable retainer 120, which is a system of cable routers in a device, in this case a load handling device. The combination of the flexible cable router 110 and the grooves 54 in the component 50 defines an elongated channel extending from the fixed component to a free and unconnected end 124 of the flexible cable router 110. Thus, the cable can be easily fitted to the device, for example, a load handling device, and can be easily accessed for maintenance. Whilst the cable 56 is shown to be retained in the groove by tabs 59, the cable may alternatively or additionally be retained in the groove by clips, such as the one shown in FIGS. 10 and 11, or alternatively or additionally, the cable may comprise overmoulded sections which have a twist-fit or push-fit arrangement with a portion of the groove, as shown in FIGS. 12 to 14. The flexible cable router 110 is attached to the groove 54 of the component by a clip 118. Specifically, the clip 118 fits into a pair of locating features 72 in the groove, in a similar way to inserting a clip 62 into the groove to retain an overmoulded section 66 of the cable 56 in the groove (as previously shown in FIGS. 10 and 11). The flexible spine 110 is arranged such that the width of the longitudinal members 114 extends horizontally (in an x-direction). This inhibits the movement of the flexible spine horizontally (in the x-direction), and the spine can only move vertically (in the y-direction). In contrast to the cable router shown in FIG. 16, the cable router in FIG. 17 comprises a continuous surface 126 between the two longitudinal members 114. In this case, the continuous surface 126 is positioned on the upper side of the cable 56, but it could equally be positioned on the lower side of the cable. The system may comprise any combination of the features of the grooves 54 or cable router 110 described above.

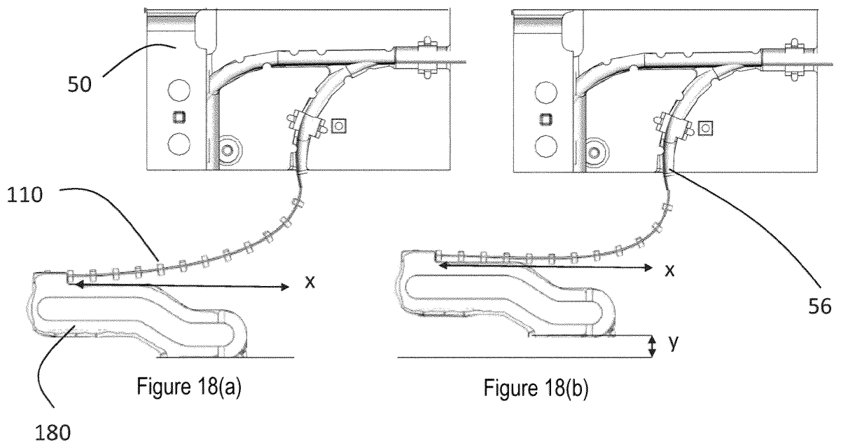

One or both of the cable routers 110 shown in FIG. 17 or the cable router of FIG. 16 may be connected from a fixed component 50 to a moving part 180 (i.e. a part that moves relative to the fixed component), as shown in FIG. 18. FIG. 18 shows the cable router in a first and second configuration. In a first configuration, as shown in FIG. 18(a) the whole spine of the cable router 110 is curved along the longitudinal direction and the cable router and cable are in a relaxed state. In the first configuration, the cable router 110 wholly deviates from the x-direction. In a second configuration, as shown in FIG. 18(b), only a portion of the spine of the cable router is curved along the longitudinal direction. Thus, in the second configuration, a portion of the cable router 110 extends along and in line with the x-direction. Specifically, the portion of the spine that is curved is the portion closest to the fixed component 50 and the portion of the spine that extends along the x-direction is the portion closest to the moving part 180. The relaxed curved state of the first configuration minimises stresses in the cable 56. When the moving part 180 moves upwards/vertically/in the y-direction (as shown by the arrow y) as shown in FIG. 18(b), the cable router 110 and therefore the retained cable 56 cannot move horizontally in an x-direction because the longitudinal members are orientated in the same way as shown in FIG. 17, so the cable router 110 folds downwards towards the moving part 180 such a portion of the cable router 110 extends along the x-direction and the cable router is in the second configuration. The cable router 110 thus restrains the movement of the cable 56 and the cable can only move in a vertical direction. This stops the cable from getting caught in the moving part 180. When the moving part 180 moves downwards back to its position in FIG. 18(a), the cable router 110 returns to the same relaxed curved state shown in FIG. 18(a). This is because the cable router 110 is biased towards the relaxed curved state so whenever the cable router is flexed or bent, the cable router 110 will return to the relaxed curved state shown in FIG. 18(a) when the cable is not externally bent by, for example, a moving part.

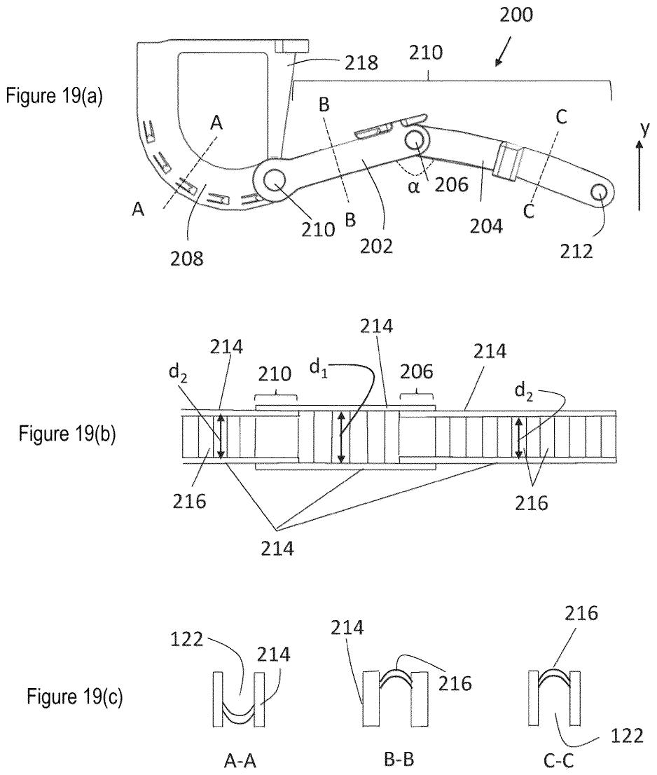

A further embodiment of a cable router 200 is shown in FIG. 19. The cable router comprises a spine comprising two opposing longitudinal members 214 which are segmented into three portions. As is similar to the cable router shown in FIG. 16, the longitudinal members 214 of the cable router 200 of FIG. 19 are spaced apart by ribs 216 which are located at regular intervals along the length of the spine. The space between the longitudinal members and the ribs creates a cable receiving space. The ribs 216 act as bridging elements bridging a gap between the two longitudinal members 214. Thus, the positioning of the ribs 216 determines how far apart the longitudinal members 214 are from each other. This means that the cable router 200 can be made to suit a particular cable.

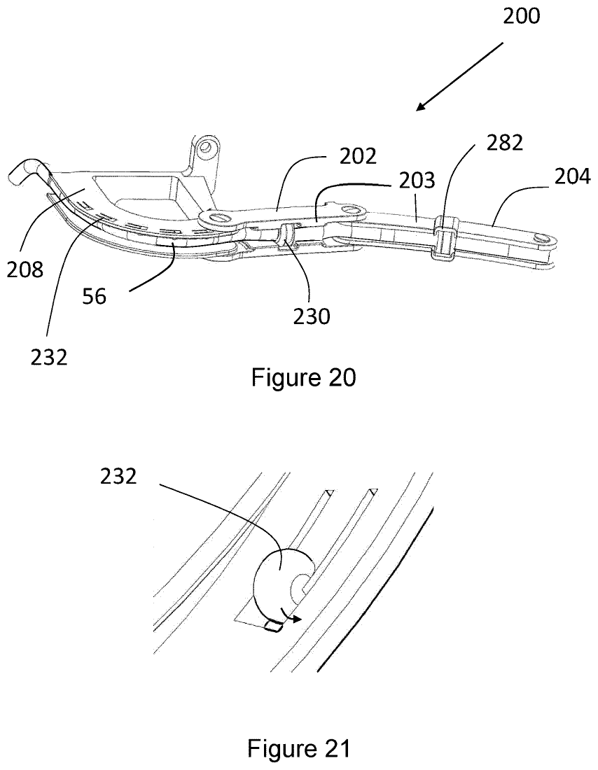

The ribs 216 shown in FIG. 19c) are all shown as curved bridging elements. However, the ribs 216 can also be straight and extend directly from one longitudinal member to the opposing longitudinal member. Alternatively, the two opposing longitudinal members can be bridged by a continuous surface. The cabling or cable 56 may be held in place within the cable receiving space by tabs or protrusions similar to that shown in FIG. 14. The cabling may also be held in place within the cable receiving space by grommets 230 as shown in FIG. 20, and explained in further detail shortly.

The three portions of the longitudinal members 214 in FIG. 19 comprise a fixed portion 208, a first linkage portion 202 and a second linkage portion 204. One end of the first linkage portion 202 is pivotally connected to the fixed portion 208 by a first joint 210. The opposing end of the first linkage portion 202 is pivotally connected to the second linkage portion 204 by a second joint 206. The opposing end of the second linkage portion 204 is connected to a moving part or component (not shown) by a third joint 212. Thus, in the cable router 200 shown in FIG. 19, there are three joints or pivots 206, 210, 212 about which the first linkage portion 202 and the second linkage portion 204 can rotate. The first joint 210 between the fixed portion 208 to the first linkage portion 202 remains in the same position in the y-direction as the first linkage portion 208 rotates about the joint 210. However, the second joint 206 between the first linkage portion 202 and the second linkage portion 204 moves up and down in the y-direction as the first and second linkage portions 202, 204 rotate about the second joint 206. The third joint 212 also moves up and down in the y-direction as the second linkage portion 204 and the moving part or component (not shown) rotate about the third joint 212. Thus, the first linkage portion 202, the second linkage portion 204, the second joint 206 between them, and the third joint 212 form a flexible structure. The second joint 206 may only move up and down in the y-direction (i.e. in a direction that is orthogonal to the transverse plane and orthogonal to the longitudinal direction) by several millimeters, for example, 10 mm, 15 mm, 20 mm or 25 mm. Thus, the movement of the cable within the cable receiving space of the cable router in limited in motion in the y-direction because the fixed portion 208 anchors one side of the first linkage portion 202 and the moving part or component moves vertically by several millimeters, for example between and including 10 mm and 25 mm, or between and including 26 mm and 50 mm, or between and including 51 mm and 75 mm, or between and including 76 mm and 100 mm. Thus, the first linkage portion 202 and the second linkage portion 204 are constrained in the angle α at which they can rotate about the first joint 206 and the second joint 212.

As shown in FIG. 19, one end of the first linkage portion 202 overlays the free end of the fixed portion 208 and the other end of the first linkage portion 202 overlays one end of the second linkage portion 204. Thus, the distance di between interior surfaces of the opposing longitudinal members of the first linkage portion 202 is greater than the distance d2 between interior surfaces of the opposing longitudinal members of the fixed portion 208 and the second linkage portion 204. Thus, the cabling within the first linkage portion may need to be additionally held in place by either tabs or protrusions and/or grommets, as described previously. Alternatively or additionally, as shown in FIG. 20, the first linkage portion 202 has thicker walls 203 than the fixed member 208 and the second linkage member 204 so that the cable receiving space has the same distance di between interior surfaces of the opposing longitudinal members along the length of the cable router 200.

FIG. 20 shows a variety of cable retaining mechanism holding a cable 56 in place in the cable router 200. The fixed portion 208 comprises spring loaded tabs or detents 232, shown in greater detail in FIG. 21. The spring loaded tabs 232 are spaced apart along the walls 203 of the fixed portion 208. As a cable 56 is pressed into the cable receiving space 122 of the cable router 200, the spring loaded tabs 232 are forced away from the cable retaining space, as shown by the arrow in FIG. 21, to allow the cable to be received into the cable receiving space 122. Immediately after the cable has been received into the cable receiving space, the spring loaded tabs 232 return to their original position as shown in FIG. 21 and stop the cable exiting the cable receiving space 122. The spring loaded tabs 232 may also be used as cable retaining mechanisms in the first linkage portion 202 and the second linkage portion 204. However, in FIG. 20, the cable 56 is retained within the cable receiving space 122 by a plurality of slots 282 shaped to receive grommets 230 which surround sections of the cable 56. The grommets 230 provide a greater surface area to engage with the walls 203 of the first linkage portion 202 and the second linkage portion 204. The interior surface of the walls 203 of the first linkage portion 202 and the second linkage portion 204 comprise slots 282 having a complementary size and shape to the grommets 230, and thus the cable 56 is more firmly gripped in the cable router 200.

The first linkage portion 202 is connected to the fixed portion 208. The fixed portion 208 is unable to move the cabling between different configurations. Instead, the fixed portion retains the cabling 56 in a fixed shape so that the pre-determined minimum bend radius of the cabling cannot be exceeded. Specifically, the fixed shape is a curved shape. For extra stability, the fixed portion 208 comprises a support 218 so that the free end of the fixed portion 208 is supported from above, thereby reducing any side to side oscillations (i.e. in the transverse plane).

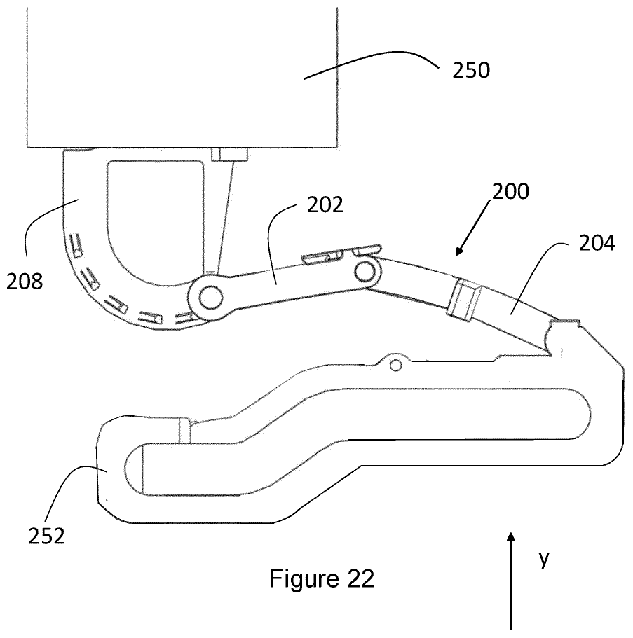

As described previously, the cable router 200 is designed to be connected between a first fixed component or part, and a second component or part that is moveable relative to the first fixed component or part. An example of this arrangement is shown in FIG. 22 which shows a fixed component or part 250 and a moveable component or part 252 which is moveable relative to the fixed component 250. The fixed component 250 may, for example, be a connecting block 43 in a modular section 44 of the open frame structure 42 of a load handling device 30, and the moveable component 252 may, for example, be a wheel positioning mechanism of a load handling device. The cable router 200 is shown in a first configuration in FIG. 22. One end of the fixed portion 208 is connected to the fixed component 250 and one end of second linkage portion 204 is pivotally connected to the moveable component 252 by the second joint 212.

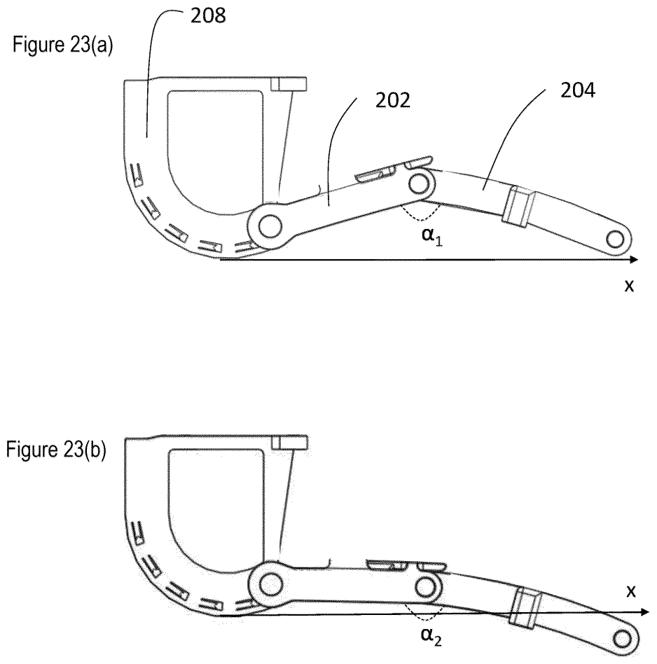

As previously described, the first linkage portion 202 and the second portion 204 are moveable between a first configuration (shown in FIG. 22 and FIG. 23(a)), such that the cabling within the first linkage portion 202 and the second linkage portion 204 is moveable up and down, i.e. in a direction that is orthogonal to the transverse plane and orthogonal to the longitudinal direction. When the moveable component 252 moves vertically upwards in the y-direction, the movement of the first linkage portion 202 and the second linkage portion 204 is constrained such that the second joint 206 moves vertically downwards in the y-direction (i.e. in the opposite direction to the movement of the moveable component 252). The cable router 200 then moves into the second configuration which is shown in FIG. 23(b). The differences between the first configuration and the second configuration of the cable router 200 are shown in FIG. 23(a) and (b). In the first configuration (FIG. 23(a)) the angle between the first linkage portion 202 and the second linkage portion 204 is an acute angle ai and the first linkage portion 202 and the second linkage portion 204 deviate from the horizontal x-direction. The first configuration is the position in which the first linkage portion 202 and the second linkage portion 204 naturally rest. In the second configuration (FIG. 23(b)) the angle α₂ between the first linkage portion 202 and the second linkage portion 204 is substantially 900. The angle α₂ may be, for example, 80°, 82°, 84°, 86°, 88° or 89°. Thus the angle α₂ in the second configuration is greater than the angle of in the first configuration. In the second configuration, the first linkage portion 202 and the second linkage portion 204 are substantially aligned with and extend in the horizontal x-direction. As particularly visible in FIG. 23(b), the second linkage portion 204 is substantially curved so that as the moveable component 252 moves vertically up and down, the cable retained within the cable retaining space does not exceed the predetermined minimum bend radius of the cable at the third joint 212. Specifically, the connection between the second linkage portion 204 and the moveable component 252 form a shallower bend for the cable when the cable router 200 is in the second configuration compared to having a straight second linkage portion. Whilst endeavouring to draw attention to the features of the invention believed to be of particular importance, it should be understood that the applicant claims protection in respect of any patentable feature or combinations of features referred to herein, and/or shown in the drawings, whether or not particular emphasis has been placed on them.

It will be appreciated that a component, cable router or cable retainer can be designed for a particular application using various combinations of the arrangements described above. It will be appreciated that the features described herein may all be used together in a single system. In other embodiments of the invention, some of the features may be omitted. The features may be used in any compatible arrangement. Many variations and modifications not explicitly described above are possible without departing from the scope of the invention as defined in the appended claims.

1-17. (canceled)

18. A cable router comprising:
a spine, the spine including two opposing longitudinal members; and
a plurality of ribs, spaced apart from each other along the spine and connecting the two longitudinal members, the spine and the ribs together providing a cable receiving space therebetween,
wherein the longitudinal members have a width extending in a transverse plane which is transverse to a longitudinal direction of the spine, and the width of the longitudinal members inhibits the cable router from bending in a plane in which the width extends, and
wherein at least a portion of the spine is configured to be moveable between a first configuration and a second configuration, wherein the spine is biased to the first configuration.

19. A cable router according to claim 18, wherein at least a portion of the spine is configured to be moveable in a direction that is orthogonal to the transverse plane and orthogonal to the longitudinal direction.

20. A cable router according to claim 18, wherein at least a portion of the spine is curved.

21. A cable router according to claim 18, wherein the plurality of ribs have an arcuate shape, and the plurality of ribs are arranged to define the cable receiving space as a cylindrical channel.

22. A cable router according to claim 18, wherein alternate ribs of the plurality of ribs are arranged along the opposing longitudinal members.

23. A cable router according to claim 18, wherein the spine comprises:
a continuous solid surface.

24. A cable router according to claim 18, wherein a portion of the spine is made from a resilient material.

25. A cable router according to claim 18, wherein each of the two opposing longitudinal members are segmented into a plurality of portions, wherein the plurality of portions include a combination of fixed portions and wherein optionally the linkage portions, and wherein optionally the linkage portions are pivotally connected to each other to form a flexible structure.

26. A cable router according to claim 18, wherein the spine comprises:
a cable retaining mechanism for retaining the cable within the cable receiving space, wherein optionally the cable retaining mechanism includes a plurality of tabs along the two opposing longitudinal members and/or a plurality of slots configured to receive an overmoulded cable or a cable including grommets.

27. A cable router according to claim 18, wherein the cable router comprises:
a fastener for engaging with a device including one or more cables for routing.

28. A cable router according to claim 1, in combination with a device comprising:
a first component;
a second component configured to be moveable relative to the first component; and
the cable router, wherein the cable router connects the first component and the second component such that the spine moves between the first configuration and the second configuration as the second component moves relative to the first component.

29. A device according to claim 28, wherein at least a portion of the spine is configured to be moveable in a direction that is orthogonal to the transverse plane and orthogonal to the longitudinal direction.

30. A load handling device for lifting and moving one or more containers stackable in a storage and retrieval system, the storage and retrieval system including a grid structure containing a plurality of grid members including a first set of grid members and a second set of grid members, the second set of grid members being substantially perpendicular to the first set of grid members such that the plurality of grid members are arranged in a grid pattern to form a grid for guiding movement of the load handling device on the grid structure, wherein the load handling device comprises:
a) a container lifting mechanism including a grabber device configured to releasably grip a container, and a drive mechanism configured to raise and lower the grabber device;
b) a wheel assembly including a first set of wheels for engaging with the first set of grid members to guide movement of the load handling device in a first direction, and a second set of wheels for engaging with the second set of grid members to guide the movement of the load handling device in a second direction, wherein the second direction is transverse to the first direction;
c) a wheel positioning mechanism configured for selectively lowering or raising the first set of wheels or the second set of wheels into engagement or disengagement with the first set of grid members or the second set of grid members;
d) electrical components including a processor for controlling the container lifting mechanism and wheel positioning mechanism; and
e) a power source for powering electrical components, wherein the power source is connected to the electrical components by cabling;
wherein the load handling device includes:
a cable router for routing cabling from the power source to the electrical components;
wherein the cable router includes:
a spine including two opposing longitudinal members; and
a plurality of ribs spaced apart from each other along the spine and connecting the two longitudinal members, the spine and the ribs providing a space for receiving the cabling;
wherein the longitudinal members have a width extending in a transverse plane which is transverse to the longitudinal direction of the spine, and the width of the longitudinal members inhibits the cable router from bending in a plane in which the width extends; and
wherein at least a portion of the spine is configured to be moveable between a first configuration and a second configuration, wherein the spine is biased to the first configuration.

31. A load handling device according to claim 30, wherein the cable router is configured to be attachable to any one or more of the container lifting mechanism, the wheel assembly, the wheel positioning mechanism and/or the electrical components.

32. A load handling device according to claim 30, wherein the load handling device comprises:
at least four connecting blocks, each of the at least four connecting blocks being connected to two other connecting blocks in a single modular section by one or more substantially horizontally connecting elements to form a rectangular frame, wherein the cable router is configured to route cabling from one of the at least four connecting blocks to any one or more of the container lifting mechanism, the wheel assembly, the wheel positioning mechanism, the electrical components and/or a second of the at least four connecting blocks.

33. A load handling device according to claim 30, wherein at least a portion of the spine is configured to be moveable in a direction that is orthogonal to the transverse plane and orthogonal to the longitudinal direction.

34. A load handling device according to claim 30, in combination with an automated storage and retrieval system, the system comprising:
a grid structure containing a plurality of grid members including a first set of grid members and a second set of grid members, the second set of grid members being substantially perpendicular to the first set of grid members such that the plurality of grid members are arranged in a grid pattern for guiding movement of one or more of the load handling devices operating on the grid structure.
